(19) United States
(12) Patent Application Publication
(10) Pub. No.: US 2010/0206492 A1
(43) Pub. Date: Aug. 19, 2010

(54) Window covering featuring automatic cord collection

(75) Inventor: Barry L. Shevick, Rancho Cordova, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(73) Assignee: Shades Unlimited, Inc.

(21) Appl. No.: 12/378,399

(22) Filed: Feb. 13, 2009

(51) Int. Cl. E06B 9/30; A47H 7/00

(52) U.S. Cl. 160/170; 160/168.1 R; 160/405

(57) ABSTRACT

A lifting mechanism is provided for a window covering which allows a bottom rail of the window covering to maintain a static position unless raised or lowered by a user. The lifting mechanism is included within either a top or bottom rail of the window covering. The lifting mechanism includes cords which pass from a rail including the lifting mechanism to the opposite rail, about cord redirecting tension sensors along the cord. The lifting mechanism includes spools and associated springs for gathering excess portions of the cord. A progressive resister is coupled to the spools to provide different amounts of resistance to spool rotation depending on the amount of cord upon each spool. The tension sensors sense cord tension and lock the cord when only tension associated with gravity is sensed and release the cord when elevated or reduced tension associated with lifting or lowering the bottom rail is sensed.

### FIELD OF THE INVENTION

The following invention relates to lifting mechanisms for window coverings. More particularly, this invention relates to lifting mechanisms for window coverings which automatically provide sufficient lifting force so that a bottom rail of the window covering will remain in a position where it is placed by a user until the bottom rail is again moved by a user to a new position, without requiring manipulation of locking mechanisms, such as buttons, cords or other manually actuated locking mechanisms.

### BACKGROUND OF THE INVENTION

Window coverings are provided in a wide variety of styles and configurations to both provide the function of at least partially occluding the passage of light through a window and enhancing an appearance of a room in which the window is located. Such window coverings can include shades which are typically continuous from a top rail at an upper end of the window covering that is typically affixed adjacent an upper end of the window, to a bottom rail at a bottom end of the window covering. Such shades can be in the form of a single layer of material or multiple layers of material and can be pleated or smooth, and can optionally include cellular “hive-like” cavities within the window covering structure itself. Window coverings can also be in the form of blinds which are typically formed of separate slats of rigid or flexible material which either have a fixed angle or can be adjusted in angle to allow some light to pass through the separate slats within the blind. Any window covering with some form of bottom rail spaced from a top rail an adjustable distance, could benefit from this invention.

The entire assembly mounted within the window can be referred to as the window covering assembly. The portion of the window covering assembly which acts to occlude the passage of light can be referred to as the window covering material, whether continuous or not and whether flexible fabric or rigid slats or other elements. The entire window covering assembly thus includes the top rail, the bottom rail and the window covering material extending between the top rail and the bottom rail.

While window coverings can be of fixed size, window coverings are usually desirably adjustable so that the window can be blocked when desired or exposed (at least partially), depending on the needs of the user. Various different prior art window covering adjustment systems are known. Most typically, cords are provided which extend from the bottom rail, through the window covering structure up to the top rail, and then continue on an exterior side of the window covering structure. A user grasps the cords and pulls the cords to raise the bottom rail towards the top rail and expose the window. The user releases the cords and the weight of the bottom rail causes the window covering to cover the window. Often locking mechanisms are also provided to assist in locking the cords to fix the bottom rail of the window covering at a desired position.

Such external cord based window covering adjustment mechanisms are less than entirely satisfactory. The cords can become entangled with themselves or other structures, rendering the cords non-functional in adjusting the position of the window covering. The cords present a safety risk, especially for infants and toddlers. Also, the locking mechanisms for locking the cord in the desired position, so that the window covering bottom rail is positioned where desired, is often difficult to use effectively and is prone to wearing out, so that the window covering is effectively stalled in either the fully open or fully closed position.

The deficiencies in external cord systems for adjusting window covering position have led to the development of “cordless” window coverings. For instance, see U.S. Pat. No. 6,644,375. Such cordless window coverings include cords which are internal, extending between the top rail and the bottom rail, but with no external cords. Some such cordless blinds utilize locking mechanisms adjacent the top rail or the bottom rail which are typically in the form of buttons. When the bottom rail is to be raised to expose the window, one or more buttons are pushed and the bottom rail is raised. When the button(s) is released, the shade remains in the selected position. When the bottom rail is to be lowered, the button(s) can again be pushed and the bottom rail repositioned before releasing the button(s) with the bottom rail in the new desired position. In at least one window covering, included in U.S. Pat. No. 6,823,925, the bottom rail can be pulled down without requiring that the buttons be pushed. Only when the bottom rail is to be raised do the buttons need to be pushed.

Other prior art window coverings have height adjustment mechanisms which rely on some form of balancing of the bottom rail so that adjustment of the height of the shade is somewhat automatic. Instead of requiring that buttons be pushed, the bottom rail is merely repositioned to a desired position. The shade then remains balanced in the new position. For instance, see U.S. Pat. No. 6,571,853.

While such balanced cordless shades are taught in the prior art, such balanced cordless shades have heretofore required complex mechanisms which have exhibited various undesirable performance characteristics. In particular, such cordless balanced shades have typically included some form of cord collecting structure, such as a spool which has been biased, such as with a spring to cause the cord running from the bottom rail up to the cord collector to be encouraged onto the spool. As the bottom rail moves downward, the strength of the spring increases, making it difficult to cause the bottom rail to remain fixed in the lower position. At a minimum, the bottom rail is inclined to bounce somewhat and not remain solidly in a fully down position. When a weaker spring or other biaser is used, it has insufficient force to keep the bottom rail from falling down at least somewhat when the user desires that the window covering be entirely open. Also, such balanced cordless shades can wear over time in a way that causes them to not stay reliably where positioned, and can get positioned with the bottom rail non-horizontal.

Variable resistance springs have been attempted, as one solution to this problem. Various cord handling mechanisms have been utilized including one-way brakes and one-way cord movement retarders to discourage such undesirable bounce. With each of these solutions, a need remains for a simple and reliable lifting mechanism for a window covering which allows a user to easily adjust a position of the bottom rail of the window covering merely by grasping the bottom rail and positioning it where desired, with confidence that the bottom rail will remain precisely where it has been left until it is again moved by the user.

### SUMMARY OF THE INVENTION

This invention provides a lifting mechanism for a window covering which facilitates a cordless window covering being easily positioned as desired and easily repositioned, by merely grasping and placing a bottom rail of the window covering where the user desires it to be. The window covering includes a top rail and a bottom rail with a window covering material supported therebetween. At least one cord (and typically two cords) extends between the top rail and the bottom rail. A cord collector is located within one of the rails with the cord coupled to the cord collector at the end of the cord adjacent the cord collector. The cord collector is coupled to a biaser which biases the cord collector in a direction encouraging the cord collector to collect the cord thereon. The cord is routed so that generally the weight of the shade counteracts the forces exerted by the biaser so that the cord remains stationary and hence the bottom rail of the window covering remains stationary, unless external forces are applied to the system.

It is desirable to keep tension on the cord to avoid slack and potential binding of the cord within the cord collector or otherwise internally within the window covering. However, it is also desirable to allow the cord to move freely during raising or lowering of the bottom rail of the window covering. These two goals are in conflict with each other. With this invention, a cord tension sensor is provided which senses the tension in the cord. When the tension in the cord is similar to that which is provided by gravity loads acting on the bottom rail and lower portions of the window covering, a high friction force is applied to the cord essentially locking the cord so that the bottom rail remains fixed. If forces acting on the bottom rail are increased or decreased, such as accompanying forces associated with a hand of a user gripping the bottom rail and raising or lowering the bottom rail, this change in tension in the cord is sensed by the cord tension sensor. The cord tension sensor then adjusts the variable resistance force on the cord to reduce or eliminate the cord resistance force so that the cord can move freely to be collected by the cord collector or released from the cord collector, as the bottom rail is raised or lowered by a user.

Additionally, a progressive resister is coupled to the cord collector. The progressive resister adds a progressive amount of resistance to motion of the cord collector as a greater amount of cord is taken away from the cord collector. Thus, when the bottom rail is most distant from the top rail and the cord is mostly off of the cord collector, the progressive resister exerts a maximum resistance force against collection of the cord by the cord collector, in effect resisting the action of the biaser upon the cord collector. When the bottom rail is closer to the top rail and a greater amount of the cord is collected with the cord collector, a relatively lesser amount of resistance is exerted upon the cord collector by the progressive resister, so that action of the biaser upon the cord collector is opposed to a lesser extent.

The action of the progressive resister allows the window covering to avoid the “bounce” phenomena associated with the biaser, such as a spring, exerting an excessive force upon the cord collector when the cord is a maximum amount away from the cord collector. Also, the progressive resister allows the cord collector to function similarly whether a large portion of the window covering material is being supported by the bottom rail (typically when the bottom rail is higher) or whether a small portion of the window covering material is being supported by the bottom rail (typically when the bottom rail is lower). As the bottom rail moves downward, more of the window covering material has its weight suspended from the top rail rather than held up by the bottom rail. The amount of resistance added by the progressive resister is thus correlated with the amount of cord collected with the cord collector and by correlation, the position of the bottom rail relative to the top rail.

When two cords are provided between the bottom rail and the top rail, preferably two cord collectors are provided with the two cord collectors preferably linked together so that they collect common amounts of cord simultaneously and release common amounts of cord simultaneously. Thus, the bottom rail remains parallel with the top rail at all times. A single progressive resister preferably acts upon both cord collectors.

In a most preferred arrangement, the cord collectors are in the form of spools with the biasers in the form of separate helical springs associated with each of the cord collectors. The spools are coupled to gears which mesh with each other and with a resistance gear coupled to the progressive resister.

While the progressive resister could take different forms, in a most preferred embodiment, the progressive resister includes a threaded shaft coupled to the resistance gear and with a bottom plate adjacent the resistance gear and a top plate spaced from the bottom plate. The top plate and bottom plate are preferably configured to avoid rotation and with the top plate coupled to a key with a threaded hole upon the threaded shaft so that the top plate moves toward and away from the bottom plate when the resistance gear rotates. A spring is interposed between the top plate and the bottom plate so that when the top plate moves toward the bottom plate, the spring is compressed and the bottom plate exerts a relatively greater amount of force against the resistance gear. The bottom plate thus resists rotation of the resistance gear and the other gears meshed therewith, including the gears coupled to the spools, a variable amount.

### OBJECTS OF THE INVENTION

Accordingly, a primary object of the present invention is to provide a window covering without any external cords and which can be adjusted in height easily and reliably.

Another object of the present invention is to provide an adjustable height window covering which has a bottom rail which remains in a position in which it is manually placed and which can be easily moved by grasping the bottom rail and moving the bottom rail to the position where desired.

Another object of the present invention is to provide a “cordless” window shade which can be adjusted in height without requiring manual actuation of a locking mechanism.

Another object of the present invention is to provide a window covering which has a bottom rail which remains parallel with a top rail at all times and which bottom rail can be easily positioned where desired relative to the top rail.

Another object of the present invention is to provide a window covering which is both free of any external cords and balanced so that the bottom rail can be positioned where desired without requiring actuation of any locking mechanisms, and which bottom rail avoids a “bounce” phenomena throughout a range of motion of the bottom rail.

Another object of the present invention is to provide a window covering which does not have any external cords and which is balanced, and can be easily cut to different widths without interfering with lifting mechanism performance.

Another object of the present invention is to provide a window covering which is free of external cords and is balanced, and which exhibits reliable performance for a long duration and with heavy use.

Another object of the present invention is to provide a window covering which is free of external cords and balanced, and which can be readily manufactured from commonly available materials while still exhibiting reliable quality performance.

Another object of the present invention is to provide a method for controlling a position of a bottom of a window covering which is simple to use and performs reliably for all positions.

Another object of the present invention is to provide a method and apparatus for controlling friction on a moving cord based on tension sensed within the cord.

Other further objects of the present invention will become apparent from a careful reading of the included drawing figures, the claims and detailed description of the invention.

### BRIEF DESCRIPTION OF THE DRAWINGS

FIG. 1 is a perspective view of a window with a window covering according to this invention installed thereon, and with a lifting mechanism of the window covering shown located within a bottom rail of the window covering.

FIG. 2 is a perspective view of a window with an alternative embodiment window covering therein having the lifting mechanism located within the top rail of the window covering, rather than in the bottom rail of the window covering, and with portions of the top rail removed to show the lifting mechanism therein.

FIG. 3 is a perspective view of portions of the lifting mechanism and cord handling structures located within an interior of the bottom rail and with the figure broken into three parts (3A, 3B and 3C) to fit on a common sheet.

FIG. 4 is a perspective view of that which is shown in FIG. 3, with a cover removed.

FIG. 5 is a full sectional view of that which is shown in FIG. 4, including the cover.

FIG. 6 is a full sectional view of an alternative spool and biasing spring, where the spring is radially inside the spool, rather than axially stacked on top of the spool, with two such modified spools (or more) potentially oriented on either side of the progressive resister shown in FIGS. 3-5.

FIG. 7 is an exploded parts view of one of two spool and spring assemblies making up a portion of the lifting mechanism of this invention.

FIG. 8 is a perspective view of a progressive resister of the lifting mechanism of this invention.

FIG. 9 is an exploded parts view of the progressive resister of FIG. 8.

FIG. 10 is a perspective view of an alternative embodiment of the lifting mechanisms of FIG. 4, with the embodiment of FIG. 10 including a pair of auxiliary springs to enhance biasing forces applied to the spools of the lifting mechanism of this alternative embodiment.

FIG. 11 is a full sectional view of that which is shown in FIG. 10.

FIG. 12 is a perspective view of a preferred form of tension sensor for use in sensing cord tension and applying a variable friction force on the cord according to this invention.

FIG. 13 is a perspective view illustrating a cord path through the tension sensor and with guide rollers of the tension sensor shown in broken lines which handle the cord as it passes through the tension sensor.

FIGS. 14-16 are top plan views of the tension sensor of FIG. 12, illustrating the modes of operation of the tension sensor, with FIG. 14 showing the tension sensor when the bottom rail is being lifted and low friction force is being applied to the cord, with FIG. 15 showing the tension sensor when the bottom rail is being lowered and the cord is substantially free of friction, and in FIG. 16 showing the tension sensor when the bottom rail is static and the cord is locked.

FIG. 17 is a full sectional view along line 17-17 of FIG. 14 further illustrating function of the cord tension sensor when the bottom rail is being lifted.

FIG. 18 is a full sectional view taken along lines 18-18 of FIG. 15 and illustrating the cord tension sensor when the bottom rail is being lowered.

FIG. 19 is an exploded parts view of the cord tension sensor of this invention exploded out of a housing in the bottom rail and with various mechanisms within the base of the cord tension sensor exploded up out of the base.

FIGS. 20-22 are perspective views of the window covering according to one form of this invention showing a measuring guide and with a cuttable rail configuration and showing the cutting tool in the process of cutting excess ends of the window covering off for sizing of the window covering to fit over a particular window.

### DESCRIPTION OF THE PREFERRED EMBODIMENT

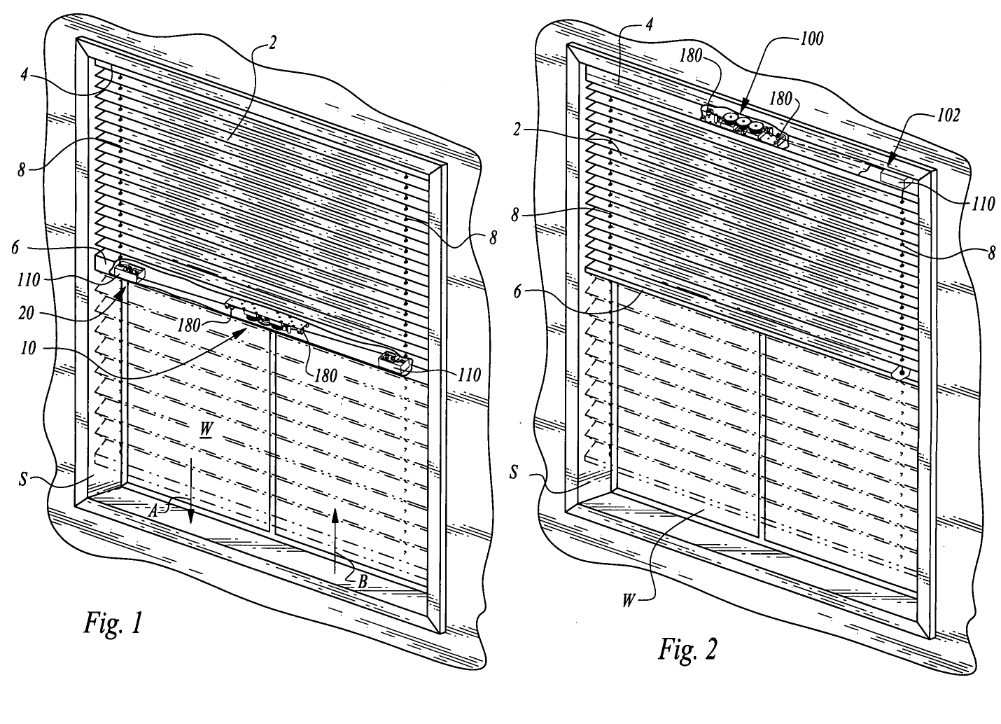

Referring to the drawings, wherein like reference numerals represent like parts throughout the various drawing figures, reference numeral 10 (FIGS. 1 and 3-5) is directed to a lifting mechanism for a window covering 2. The window covering 2 generally includes a top rail 4 parallel with and spaced from a bottom rail 6 with a window covering material structure extending between the top rail 4 and bottom rail 6.

Cords 8 extend between the top rail 4 and the bottom rail 6. The lifting mechanism 10 acts upon the cords 8 within one of the rails 4, 6 so that the bottom rail 6 can maintain equilibrium wherever the bottom rail 6 is positioned by a user. In this way, a user can raise the bottom rail 6 (arrow B of FIG. 1) or lower the bottom rail 6 (arrow A of FIG. 1) to expose the window W or occlude the window W, with the bottom rail 6 conveniently remaining where it is left by the user.

In essence, and with particular reference to FIGS. 1 and 3-5, basic details of the lifting mechanism 10 are described. The lifting mechanism 10 is preferably located within a central portion of the bottom rail 6 of the entire window covering assembly. The cords 8 extend out of the lifting mechanism 10 in opposite horizontal directions to cord tension sensors 110 also within the bottom rail 6. The tension sensors 110 redirect the cords 8 from extending horizontally within the bottom rail 6 to extending substantially vertically up to the top rail 4.

The cords 8 interface with the lifting mechanism 10 through spools 30 which are configured to collect the cords 8 thereon and release the cords 8 therefrom, depending on the position of the bottom rail 6 relative to the top rail 4. Springs 40 are coupled to each of the spools 30. The springs 40 bias the spools 30 toward collecting the cords 8 upon the spools 30. The springs 40 thus attempt to counteract gravity forces acting upon the bottom rail 6 and tending to pull the cords 8 off of the spools 30.

A progressive resister 50 is provided which exerts progressively greater resistance to spool 30 rotation as progressively greater amounts of cord 8 are released from the spools 30. The progressive resister 50 thus acts against the forces exerted by the springs 40 upon the spools 30. This allows for enhanced shade positioning performance, such as to accommodate weight transfer from the bottom rail to the top rail as the bottom rail moves down. Preferably the progressive resister 50 is coupled to the spools 30 through a gear set 80.

More specifically, and with particular reference to FIG. 1, details of the window covering 2 and associated structures are provided. The lifting mechanism 10 of this invention, also referred to as a “winding mechanism,” is included within an overall window covering assembly. The window covering 2 assembly specifically includes the window covering material extending between the top rail 4 and the bottom rail 6.

The top rail 4 is preferably a rigid elongate structure. The top rail 4 is configured so that it can be fastened to an upper portion of a casing S surrounding a window W. The top rail 4 suspends the entire window covering 2 assembly from the casing S. The top rail 4 can be fastened to the casing S with adhesive, with mechanical fasteners, or with other fastening methodologies known in the window covering arts. Two such fasteners are described in corresponding U.S. Published Patent Application Nos. 2006/0081746 and 2008/0011922. The top rail 4 can optionally include the lifting mechanism therein along with the cord tension sensor 110 pair, inverted to redirect cord from horizontal to vertically downward (FIG. 2). Preferably, however, the top rail 4 does not include the lifting mechanism 10 therein. If necessary, the top rail 4 can be reinforced adjacent where the cords 8 are affixed to the top rail 4. Also, while two cords 8 are shown in this embodiment, one cord 8 or more than two cords 8 could be provided.

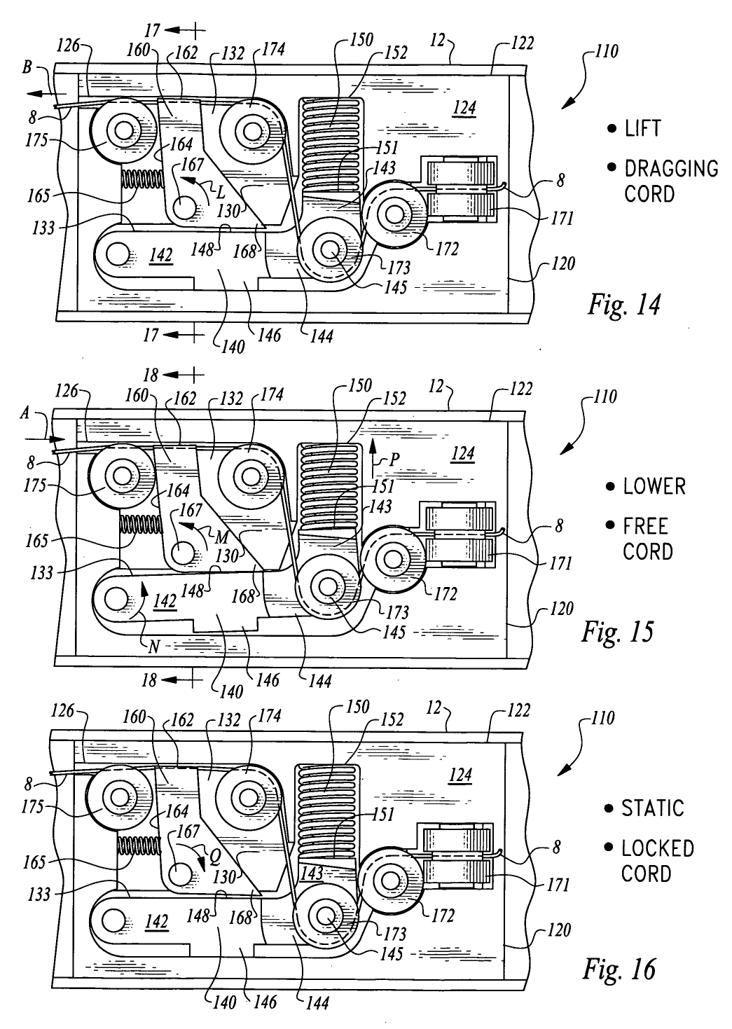

The bottom rail 6 is an elongate substantially rigid structure. The bottom rail 6 is preferably hollow so that the lifting mechanism 10 can be placed therein. The bottom rail 6 preferably includes the lifting mechanism 10 therein, but can optionally be vacant with the lifting mechanism 10 included in the top rail 4 (FIGS. 13 and 14). The bottom rail 6 also acts as a grasping structure to allow a user to grab and reposition the bottom rail 6 where desired.

The window covering material extending between the top rail 4 and the bottom rail 6 can be any of a variety of different window covering materials known in the art. For instance, the window covering 2 can be in the form of a continuous shade which is either pleated or unpleated, and can form either a single layer between the top rail 4 and the bottom rail 6 or include multiple layers. If multiple layers are included, these layers can be coupled together such that the window covering 2 takes on a cellular form with a “hive-like” cross-section. The window covering 2 could also be in the form of blinds made up of separate slats tethered together that may be fixed or rotatable to vary an amount of light passing therethrough.

At least one cord 8 extends between the top rail 4 and the bottom rail 6. Most preferably, two cords 8 are provided between the top rail 4 and the bottom rail 6. Optionally, more than two cords 8 could be provided. Each of the cords 8 is preferably substantially circular in cross-section and formed of a flexible woven textile material or a flexible plastic material such as nylon or polyethylene. Alternatively, the cords 8 could be in the form of metal chain, plastic chain, fabric chain, flexible tape, flexible ribbon, or any other flexible elongate structure suitable for suspending the bottom rail 6 from the top rail 4 and being handled by the various cord handling mechanisms of this invention. When the term cords is used, it is used generally to refer to any such elongate flexible structures.

The window covering material, top rail 4, bottom rail 6 and cords 8 together form the window covering 2 assembly which includes the lifting mechanism 10 according to this invention. The entire window covering 2 assembly is preferably configured to be readily adjusted in width to generally match a width of the casing S adjacent the window W. Specifically, the lifting mechanism 10 and the cord redirectors 20 are preferably located sufficiently near to a center of the window covering 2 assembly so that about half of the overall width of the window covering 2 assembly is between the cords 8 and about one-fourth of the window covering 2 assembly is on either side of the cords 8. The window covering material, top rail 4 and bottom rail 6 can thus be cut, typically with equal amounts being cut from each end of the window covering material, top rail 4 and bottom rail 6, to adjust to a width of the casing S down to nearly one-half of the original width of the window covering 2 assembly.

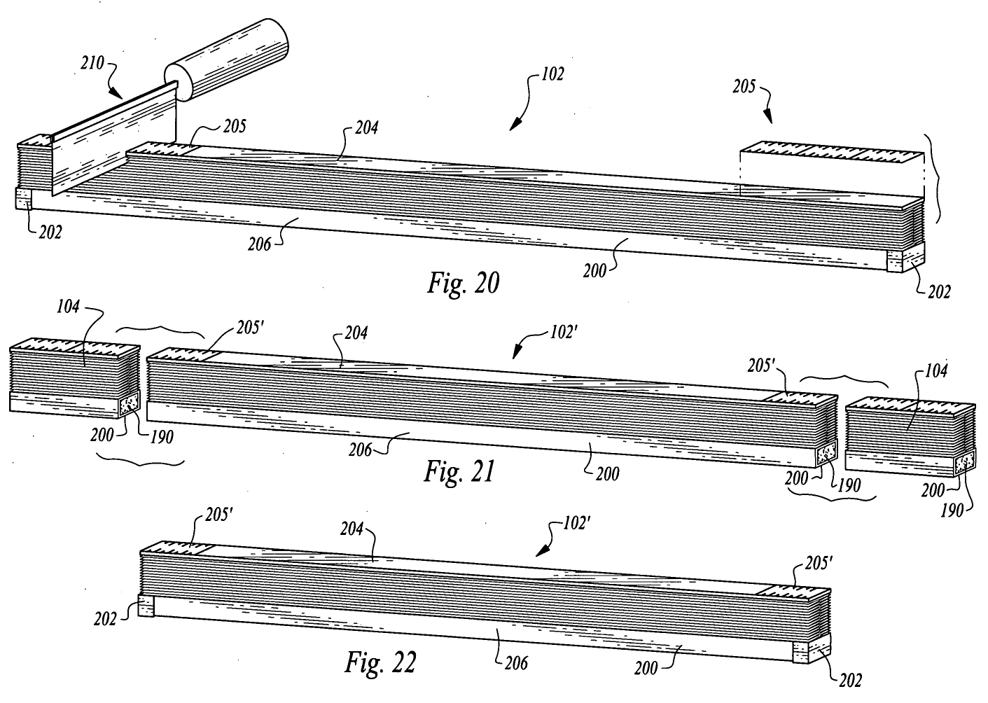

Numerous different window cutting methodologies and cutting tools can be utilized to facilitate such cutting, such as described below in conjunction with FIGS. 20-22. One such tool and associated methodology is described in U.S. Pat. No. 6,865,817, incorporated herein by reference.

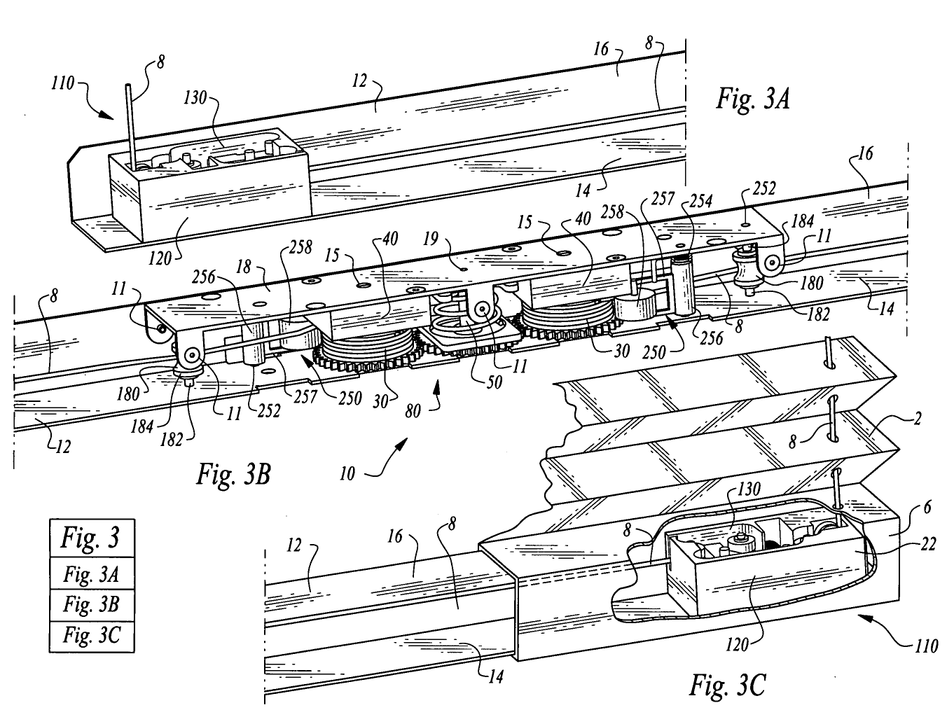

With particular reference to FIGS. 3-6, particular details of a housing 12 for the lifting mechanism 10 and the cord tension sensor 110 of this invention are described. The bottom rail 6 (FIGS. 1 and 3) is preferably hollow with a generally elongate rectangular geometry. The lifting mechanism 10 is preferably mounted upon a housing 12 which is sized slightly smaller than the hollow interior of the bottom rail 6 so that the housing 12 of the lifting mechanism can fit securely within the bottom rail 6. As an alternative, the housing 12 and bottom rail 6 could be integrated together.

The housing 12 is an elongate rigid structure which supports the various different components of the lifting mechanism 10 to securely hold these components in precise position relative to each other to maximize desirable function for the lifting mechanism 10. The housing 12 thus includes a generally flat horizontal floor 14 with walls 16 extending perpendicularly up from front and rear sides of the floor 14. A cover 18 is separately provided which spans upper edges of the walls 16 to close the housing 12 (FIG. 3). Cover screws 11 (FIG. 3) are provided to secure the cover 18 to the housing 12.

The housing 12 preferably includes multiple holes through which various different components are supported. These holes include alignment holes 15 for maintaining alignment of the spools 30 and associated structures. The housing 12 also includes gear clearance holes 17 which allow the gears such as the spool gears 82 coupled to the spools 30 and the resistance gear 84 coupled to the progressive resister 50 to have a maximum diameter and to allow the housing 12 to be formed by bending the walls 16 up from the floor 14 without concern for any curvature where the walls 16 and floor 14 are joined together. An alignment hole 19 is further provided to maintain alignment of the progressive resister 50 relative to the housing 12.

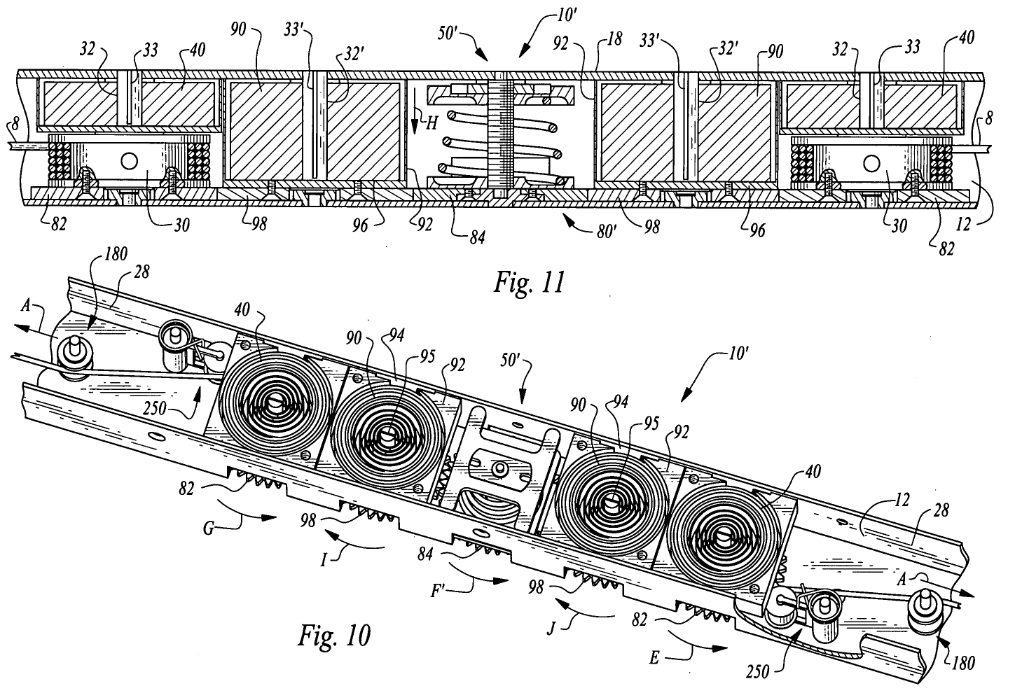

Additional holes are provided on the housing 12 such as to facilitate the inclusion of the auxiliary springs 90 and associated equipment for the alternative embodiment of FIGS. 10 and 11. If the housing 12 were to be placed within the top rail 4 rather than the bottom rail 6, the housing 12 would be substantially the same, except that it would be reversed as necessary to allow the cords 8 to extend down from the housing 12, rather than extending up from the housing 12.

With particular reference to FIGS. 14-16, details of the operation of the tension sensor 110 are described according to this preferred embodiment. Initially, the window covering 2, 102 (FIGS. 1 and 2) will be in a static position, with the bottom rail 6 stationary relative to the top rail 4. With such a static orientation, the cord 8 is fixed relative to the base 120 and other portions of the tension sensor 110. It is desirable that the cord 8 be locked when a bottom rail 6 is static relative to the top rail 4. As depicted in FIG. 16, the cord tension sensor 110 is shown locking the cord 8 by action of the pawl 160, and particularly the engagement surface 162 of the cord 8 against the adjacent portion of the side walls 136 of the cavity 130.

Gravity forces acting on the bottom rail 6 are converted into tension in the cord 8 when the bottom rail 6 is static. To keep the bottom rail 6 from moving downward under gravity loads, the progressive resister 50 acts on the cord collector, including the spools 30 and the associated biaser in the form of the springs 40, so that cord 8 does not come off of the spools 30 and the bottom rail 6 remains static.

Such a static position of the bottom rail 6 is further assisted by engagement of the cord 6 by the pawl 160 within the cord tension sensor 110. In particular, the bias spring 165 acts on the pawl 160 to rotate the pawl 160 counter-clockwise (about arrow Q of FIG. 16). Such pawl 160 rotation occurs until the engagement surface 162 has pinched the cord 8 against a portion of the side walls 136 of the cavity 130 adjacent to the engagement surface 162. Furthermore, as such cord 8 motion exerts force to try to continue motion, the pawl 160 rotates tighter to further enhance clamping. Thus, the spring 165 need only be sufficient to set the engagement surface 162 of the pawl 160 against the cord 8. Thus, the cord 6 is prevented from movement relative to the tension sensor 110 and associated bottom rail 6 (or top rail 4).

Should the user desire to raise the bottom rail 6, the user grips the bottom rail 6 and lifts on the bottom rail 6. When this lifting force is encountered by the bottom rail 6, it is in a direction opposite gravity forces so that net forces downward on the bottom rail 6 are reduced. In turn, such reduction reduces tension on the cord 8 to a level which is less than cord collection forces applied by the biaser 40 acting on the spools 30 or other cord collectors, so that the spools 30 start to collect the cord 8, by motion of the cord 8 from the cord tension sensor 110 toward the cord collector, such as the spool 30 (along arrow B of FIG. 14).

These forces applied by the biaser of the cord collector are sufficiently strong to counteract forces applied by the bias spring 164 within the tension sensor 110, so that the pawl 160 rotates in a counter-clockwise direction slightly (along arrow L of FIG. 14). With such rotation, the engagement surface 162 moves slightly away from the portion of the side walls 136 of the cavity 130 adjacent the engagement surface 162. Thus, cord 8 can more freely move past the pawl 160 (FIG. 17).

Most typically, engagement surface 162 still drags slightly against the cord 8 when in this condition, but any friction forces applied by the pawl 160 on the cord 8 are less than the strength of the biaser within the cord collector which is drawing the cord 8 onto the spools 130 or other cord storage space within the cord collector. Such movement of the cord 8 past the pawl 160 (along arrow B of FIG. 14) continues until a user stops applying an upward force on the bottom rail 6. When the user stops applying this upward force on the bottom rail 6, the full gravity force is again applied to tension the cord 8, and this force is sufficiently great to overcome forces applied by the cord collector, so that the bottom rail 6 is generally in balance. Furthermore, the bias spring 165 of the pawl 160 is no longer overcome, and this bias spring 165 causes the pawl 160 to again rotate counter-clockwise (about arrow Q of FIG. 16) to again lock the cord 8 to further assist in holding the bottom rail 6 fixed.

Should a user desire to lower the window covering 2, the user grasps the bottom rail 6 and applies a downward force on the bottom rail 6. This downward force acts in addition to gravity forces so that tension on the cord 8 is greater than tension associated with gravity forces alone. The compression spring 150 is selected so that it cannot be compressed when tension forces on the cord 8 are those associated with gravity forces alone. However, when additional downward forces are applied and the tension in the cord 8 exceeds the tension associated with gravity forces alone, the compression spring 150 is compressed (along arrow P of FIG. 15).

Along with such compression, the lever 140 is caused to rotate in a counter-clockwise direction (about arrow N of FIG. 15). Such rotation of the lever 140 continues until the lever 140 has its inside surface 148 abut the pawl 160 at the abutment tip 168. Lever 140 rotation in turn causes the pawl 160 to rotate (about arrow M of FIG. 15), causing the cord 8 to have an essentially free path (or at least a minimally restrictive path) past the engagement surface 162 of the pawl 160 and past the portion of the side walls 136 of the cavity 138 adjacent the engagement surface 162 (FIG. 18). Thus, the cord 8 is free to move. The gravity load and the downward force acting on the bottom rail 6 causes the bottom rail 6 to move downward and the cord 8 is free to move off of the cord collector with motion through the tension sensor 110 along arrow A (FIG. 15).

When a user has positioned the bottom rail 6 where desired, the user need merely stop pulling down on the bottom rail 6. At this point only gravity loads are again acting on the bottom rail 6 and the lever 140 rotates clockwise back to its original position (FIG. 16) and the pawl 160 rotates clockwise back to its original position (along arrow Q of FIG. 16) by action of the bias spring 165. The pawl 160 thus again locks the cord 8 with the bottom rail 6 in the new static position.

As described in detail below, gravity forces acting on the bottom rail 6 are not necessarily merely the weight of the bottom rail 6, but also can include some portion of weight of window covering material between the top rail 4 and the bottom rail 6. To account for this variable gravity force for different positions of the bottom rail 6, the progressive resister 50 provides a variable amount of resistance to cord collector forces acting on the cord 8, so that the window covering 2, 102 functions in a similar manner whether the bottom rail 6 is near a bottom of a window covering space or near a top of a window covering space.

While the tension sensor 110 has been disclosed for use in conjunction with the lifting mechanism 10, it is conceivable that the lifting mechanism 10 could be replaced with some other lifting device, such as a motor. Such a cord tension sensor 110 could still be utilized. In such a system, the cord tension sensor would help to detect whether the motor is in a cord collection or cord release mode (or static) and add friction, reduce friction or lock the cord accordingly when such a motorized lifting mechanism is idle.

With particular reference to FIGS. 3-5 and 7, details of the spools 30 and springs 40 of the preferred embodiment of the lifting mechanism 10 of this invention are described. The spools 30 and springs 40 provide primary components of the lifting mechanism 10 which causes the cord 8 to be gathered up or played out from the lifting mechanism 10 and correspondingly allow the bottom rail 6 to be lifted (arrow B of FIG. 1) or lowered (arrow A of FIG. 1). The spools 30 provide a preferred form of cord collector for gathering up the cord 8 when the bottom rail 6 is raised and for playing out the cord 8 when the bottom rail 6 is lowered.

Most preferably, two spools 30 or other cord collectors are provided, with each of these spools 30 coupled to a separate one of the two cords 8 of the preferred embodiment. It is conceivable that a single spool 30 could be coupled to a single cord 8 or that a single spool 30 could simultaneously gather two or more cords 8 and still function according to this invention. Also, more than two spools 30 could be provided and more than two cords 8.

Other forms of cord collectors which can function as a means to collect cords within the lifting mechanism 10 of this invention could include cord gathering cavities into which the cord 8 could be fed and released without winding of the cord, or multiple axle cord collection spindles, or other components capable of gathering up the cord 8 and containing the cord 8 in a defined region until the cord 8 is to be released.

According to the preferred embodiment, each of the spools 30 includes a central post 32 rigidly coupled thereto. The post 32 includes a slit 33 therein for connection to an associated spring 40 or other biaser, discussed in detail below. The spools 30 include an upper wall 34 spaced from a lower wall 35, with each of the walls 34, 35 defining portions of the spools 30 which extend radially away from the post 32 and a rotational central axis of the spools 30, a greater amount than other portions of the spools 30. A space between the walls 34, 35 defines a cord collection region for the spool 30. The walls 34, 35 keep the cord 8 from working its way off of the spools 30 and becoming entangled within other portions of the lifting mechanism 10.

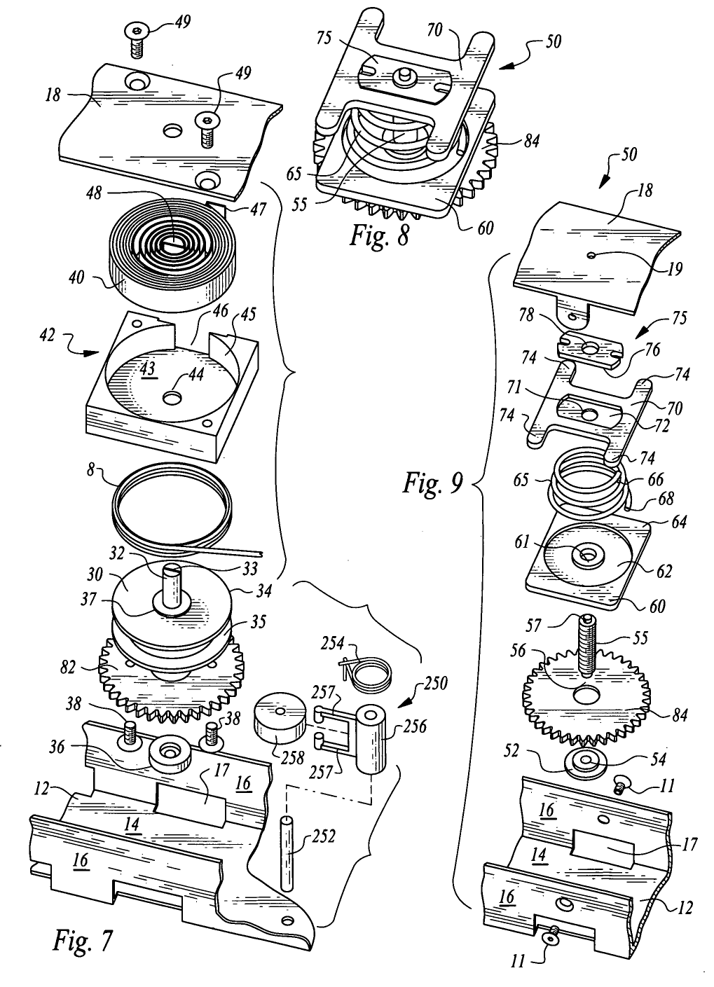

A lower bearing 36 is provided with a generally doughnut shape and which supports a lower end of the post 32 in a rotating fashion. The lower bearing 36 preferably remains stationary, but could optionally rotate, and rests within a hole in the floor 14 of the housing 12 (FIG. 7). The lower bearing 36 provides rotational support for the spool 30 and keeps the post 32 of the spool 30 from translating while allowing the post 32 and spool 30 to freely rotate. The lower bearing 36 also keeps a spool gear 82 spaced above the floor 14 of the housing 12.

An upper bearing 37 adjacent the upper wall 34 separates rotating portions of the spool 30, including the upper wall 34, from portions of the spring 40 adjacent thereto, so that friction contact and associated resistance is minimized between the spool 30 and the adjacent spring 40. Gear screws 38 attach the spool gear 82 (described in detail below) to the lower wall 35 of the spool 30. Thus, the spool 30 and associated post 32 are caused to rotate along with the spool gear 82.

The springs 40 provide a preferred form of biaser for the spools 30 or other cord collectors. Preferably, one spring 40 is provided for each spool 30. However, multiple springs 40 can be provided for each spool 30, or a single spring 40 could be provided for multiple spools 30. The springs 40 act as a preferred form as a means to bias the spools 30 or other cord collection means toward collecting more of the cord 8 upon the spool 30. Thus, the springs 40 tend to cause the cord 8 to be wound up onto the spools 30.

Countervailing forces including the weight of the bottom rail 6 and associated components located within the bottom rail 6, as well as friction with elements of the system, counteract this biasing force of the spring 40. The bottom rail 6 of the window covering 2 assembly thus remains stationary in a position where it is placed by a user, unless a user adds a lifting force upward (along arrow B of FIG. 1) or downward (along arrow A of FIG. 1) to counteract the equilibrium between the forces applied by the springs 40 upon the spools 30 and weight forces and friction forces applied to the spools 30, as well as friction added by the cord tension sensor 110.

While the springs 40 provide a preferred form of biaser, other forms of biasers could similarly be utilized to provide a means to bias the spool 30 or other cord collector toward collecting more of the cord 8. For instance, the biaser could be in the form of a resilient structure such as a rubber band. The biaser could also be in the form of various different configurations of springs, rather than merely the helical spring 40 of the preferred embodiment.

The spring 40 of the preferred embodiment resides within a cavity 42 which acts as a housing for the spring 40 to keep the workings of the spring 40 from being obstructed. The cavity 42 includes a generally flat floor 43 with a post hole 44 therein which allows the post 32 to extend up through the cavity 42. The cavity 42 additionally includes sides 45 which are generally cylindrical in form facing the cavity 42.

A gap 46 is formed in one of the sides 45. This gap 46 helps to anchor one end of the spring 40 in a stationary fashion while an opposite end of the spring 40 is coupled to the post 32. Specifically, the spring 40 is preferably in the form of a helical spring having an outer tab 47 at an outermost end of the spring 40 and an inner tab 48 at an innermost end of the spring 40. The outer tab 47 is configured to pass through the gap 46 and be secured to the cavity 42 structure.

Because the cavity 42 is generally square in form, it is not capable of rotating within the housing 12 (FIG. 3). Additionally, cavity screws 49 are preferably utilized to secure the cavity 42 to the cover 18 to further prevent the cavity 42 and the outer tab 47 connected thereto from moving.

The inner tab 48 is oriented within the slit 33 in the post 32. Hence, when the spool 30 rotates and the post 32 rotates along with the spool 30, the inner tab 48 of the spring 40 is also caused to rotate. Such rotation of the inner tab 48 causes the spring 40 to be wound up or wound down, depending on the direction of rotation of the spool 30. In this way, the spring 40 acts according to the preferred embodiment to bias the spool 30 or other cord collector toward collecting greater and greater amounts of the cord 8 upon the spool 30 or other cord collector.

With particular reference to FIGS. 3-5 and 7-9, particular details of the progressive resister 50 of the preferred embodiment are described. The progressive resister 50 provides a preferred form of a means to resist motion of the spool 30 or other cord collector. The progressive resister 50 thus introduces a friction force which acts with gravity forces to oppose the biasing forces associated with the spring 40 or other biaser, so that equilibrium can be provided for the spool 30 or other cord collector and a position of the bottom rail 6 can be maintained unless external forces, such as those provided by a hand of a user, are applied to the bottom rail 6.

The progressive resister 50 of the preferred embodiment preferably is provided as a single unit which acts upon a pair of spools 30 with each of the spools 30 acting upon a separate one of two cords 8 within the window covering assembly. Alternatively, a single progressive resister 50 could act upon a single spool 30 or other cord collector in a single cord version of the window covering assembly. Similarly, multiple progressive resisters 50 could be provided acting upon a single spool 30 or upon multiple spools 30. In embodiments where multiple progressive resisters 50 are utilized, each spool 30 can have its own progressive resister 50. The multiple spools 30 can either be linked together by gears or otherwise, or the spools 30 can be independent of each other.

The progressive resister 50 according to the preferred embodiment includes a base bearing 52 which supports other portions of the progressive resister 50 above the floor 14 of the housing 12. The base bearing 52 preferably extends at least partially into a hole in the floor 14 of the housing 12 (FIG. 9) so that the base bearing 52 and other portions of the progressive resister 50 are prevented from translating, but rather are restricted only to rotation. Bearing screws 53 preferably secure the base bearings 52 to a resistance gear 84 forming part of the gear set 80 described in detail below. This preferred arrangement (FIG. 9) causes the base bearing 52 to rotate along with the resistance gear 84. Alternatively, the bearing screws 53 can be omitted and the resistance gear 84 can rotate relative to the base bearing 52.

The base bearing 52 includes a bore 54 in an upper end thereof. The bore 54 is aligned with a central axis of the base bearing 52 and supports a threaded shaft 55 of the progressive resister 50 extending vertically up from the bore 54 of the base bearing 52. Particularly, the threaded shaft 55 preferably includes a lower tip 56 which extends down into the bore 54. An upper tip 57 of the threaded shaft 55 extends into the alignment hole 19 and the cover 18 of the housing 12 (FIGS. 2 and 7) so that the threaded shaft 55 of the progressive resister 50 is prevented from translating, but rather is only allowed to rotate about a vertical central axis of the threaded shaft 55.

The lower tip 56 of the threaded shaft 55 can be keyed and have a contour matching that of the bore 54 so that the threaded shaft 55 rotates with the base bearing 52. Alternatively, or in addition a fastener can be utilized to secure the lower tip 56 of the threaded shaft 55 within the base 24. When the base bearing 52 is fastened to the resistance gear 84 with the bearing screw 53 (FIG. 9) and the lower tip 56 of the threaded shaft 55 is secured into the bore 54, rotation of the resistance gear 84 causes corresponding rotation of the base bearing 52 and the threaded shaft 55.

Alternatively, the lower tip 56 of the threaded shaft 55 can rotate relative to the bore 54. In such an embodiment (FIG. 10) a lower portion of the threaded shaft 55 would be affixed to the resistance gear 84 directly, so that the threaded shaft 55 always rotates along with the resistance gear 84.

A bottom plate 60 of the progressive resister 50 is oriented directly adjacent the resistance gear 84. The bottom plate 60 provides a preferred form of brake with a lower surface of the bottom plate 60 abutting the resistance gear 84 and with this abutment imparting a resistance force against free rotation of the resistance gear 84, which is proportional to a force with which the bottom plate 60 is pressed against the resistance gear 84. The bottom plate 60 has a generally square form so that it is prevented by the walls 16 of the housing 12 from rotating. Hence, the bottom plate 60 does not rotate along with the resistance gear 84 and the threaded shaft 55.

The bottom plate 60 includes a center hole 61 through which the threaded shaft 55 is allowed to pass without contact or obstruction. A recess 62 is preferably formed in an upper surface of the bottom plate 60. The recess 62 facilitates support of a compression spring 65 adjacent the upper surface of the bottom plate 60. A perimeter 64 of the recess 62 is generally cylindrical and has a diameter similar to a lower portion of the compression spring 65. Thus, the compression spring 65 is held within the recess 62 and is prevented from translating laterally relative to the bottom plate 60 and other portions of the progressive resister 50.

The compression spring 65 includes an upper end spaced from a lower end 68. The lower end 68 abuts the bottom plate 60 within the recess 62. The upper end 66 abuts a top plate 70 of the progressive resister 50. The compression spring 65 is preferably generally helical in form and particularly configured so that a spring force of the compression spring 65 increases as the compression spring 65 is compressed between the upper end 66 and the lower end 68, such as by moving the top plate 70 toward the bottom plate 60.

To maximize a degree of travel between the upper end 66 and the lower end 68, the compression spring 65 can be slightly conically tapered with the upper end 66 having a slightly smaller diameter than the lower end 68. In this way, the compression spring 65 can be collapsed with turns in the compression spring 65 being progressively inboard of each other and maximizing a degree of collapse which can be experienced by the compression spring 65. Alternatively, the compression spring 65 could be replaced with other forms of springs or resilient structures which would be capable of exerting a force down upon the bottom plate 60 when the top plate 70 is lowered against upper portions of the force applying structure.

The top plate 70 is generally planar with a lower surface of the top plate 70 adapted to abut the upper end 66 of the compression spring 65. A center hole 71 passes through the top plate 70, allowing the threaded shaft 55 to pass therethrough. The top plate 70 preferably includes a depression 72 therein which is shaped to support a threaded key 75 within the top plate 70. Alternatively, a threaded key 75 can be integrally formed with other portions of the top plate 70. The depression 72 is sized to allow the threaded key 75 to fit snugly therein so that the threaded key 75 and top plate 70 act together as a single unit. By making the threaded key 75 from a separate structure from other portions of the top plate 70, the threaded key 75 can be formed of a harder material than the top plate 70 to maximize performance of the top plate 70 and coaction with the threaded shaft 55.

The top plate 70 includes arms 74 which extend away from the center hole 71 and are adapted to abut the walls 16 of the housing 12. The top plate 70 is thus held by the arms 74 so that the top plate 70 cannot rotate. Rather, the top plate 70 can only translate vertically along a central axis of the threaded shaft 55.

The threaded key 75 includes a perimeter contour 76 matching that of the depression 72 so that the threaded key 75 fits securely within the depression 72. A threaded hole 78 passes through the threaded key 75. The threaded hole 78 includes threads therein which match a pitch of the threaded shaft 50.

To maximize a range of travel of the top plate 70, the threaded shaft 55 and threaded key 75 preferably have a very shallow pitch to their corresponding threads. When the resistance gear 84 rotates, the threaded shaft 55 rotates along with the resistance gear 84. The threaded key 75 translates vertically (along arrow H of FIG. 5) along the threaded shaft 55 with the top plate 70 when the threaded shaft 55 is rotating.

When such rotation is in a direction causing the top plate 70 to move toward the bottom plate 60, the compression spring 65 is compressed a greater and greater amount. As the compression spring 65 is compressed, it exerts a progressively greater force vertically down upon the bottom plate 60. The bottom plate 60 is thus urged with greater and greater force against the resistance gear 84. This in turn makes it progressively more difficult for the resistance gear 84 to rotate along with the spool gear 82 coupled to the spool 30.

With particular reference to FIGS. 3-5, details of the gear set 80 of the lifting mechanism 10 of this invention are described. The gear set 80 provides a preferred means for coupling the spools 30 or other cord collectors to the progressive resister 50 or other means to resist rotation of the cord collectors. Particularly, in the preferred embodiment a single resistance gear 84 is located between two spool gears 82 with each of the spool gears 82 associated with a separate spool 30. The gears 82, 84 are all meshed together so that rotation of the spool gears 82 requires rotation of the resistance gear 84. When resistance to resistance gear 84 rotation is induced by the progressive resister 50, rotation of the spool gears 82 is similarly resisted. Thus, resistance to spool 30 rotation and associated cord collection is provided by the progressive resister 50. As an alternative, the gear set 80 could include idler gears between the adjacent gears 82, 84, or additional gears could be provided with additional function associated with such additional gears.

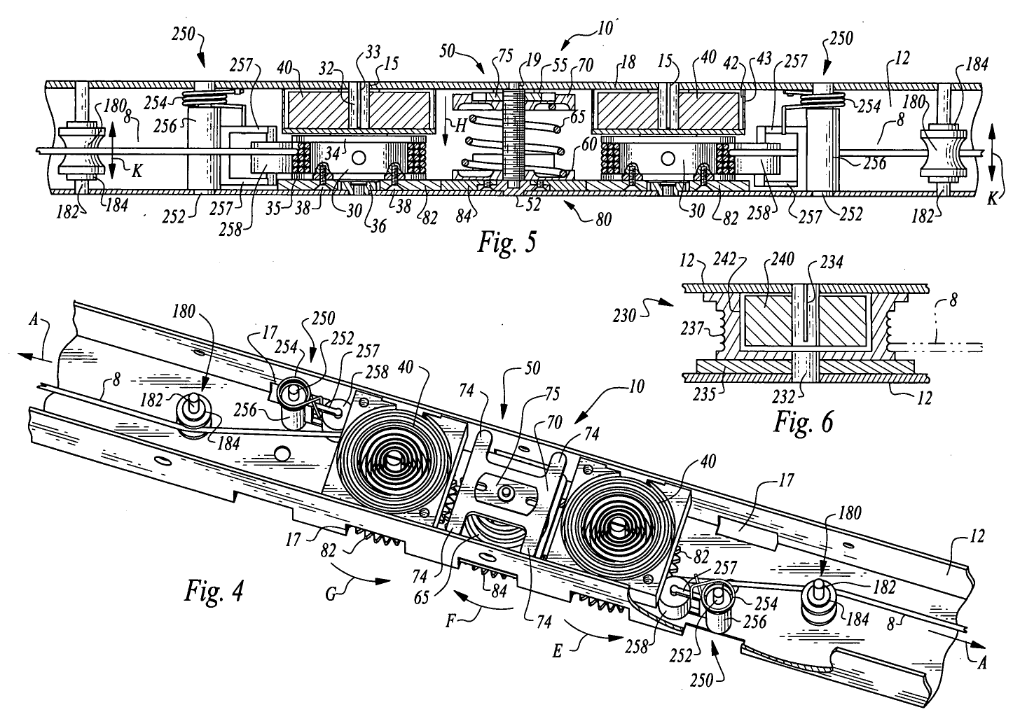

In the preferred embodiment, the spool gears 82 preferably rotate in a common direction (about arrows G and E of FIG. 4), with the resistance gear 84 rotating in an opposite direction (about arrow F of FIG. 4). Arrows E, F, G of FIG. 4 correspond with the cord 8 being played off of the spools 30, as would be the case when the bottom rail 6 is being lowered (along arrow A of FIG. 1). When the bottom rail 6 is being raised (along arrow B of FIG. 1), each of these arrows would be reversed to indicate reverse direction for the gears 82, 84.

While the gear set 80 provides the preferred form of coupling the progressive resister 50 to the spools 30, other forms of coupling could be provided. For instance, the progressive resister 50 could act directly upon the spools 30. For instance, in place of the springs 40, a progressive resister 50 could press directly against the upper wall 34 of the spool 30 through the bottom plate 60 so that resistance to spool 30 rotation would result. In such an arrangement, the springs 40 or other biasers would still need to be coupled to the spools 30 so that appropriate biasing forces tending to collect cord 8 upon the spool 30 would be provided. Options for such spring coupling including placement radially inboard of the spool 30 (as in the alternative spool 230 of FIG. 6), or gearing the spring 40 or other biaser to the spool 30.

The gear set 80 advantageously links the spools 30 together so that in window coverings 2 with two or more cords 8, the cords 8 are gathered in equal amounts onto the spools 30 and the bottom rail 6 remains horizontal and parallel to the top rail 4. Such linking is not required however. Also, linking of the spools 30 as well as other components could be provided with alternative means to link the components together. For instance, belts, chains, sprockets, shafts and other mechanical couplings could be utilized to link the components together.

If sufficient height were available within the rails 4, 6 housing the lifting mechanism 10, it is conceivable that both the spools 30, springs 40 and progressive resisters 50 could all be stacked together vertically. If a particularly low profile rail 4, 6 is desired, the spools 30, springs 40 and progressive resisters 50 could all be laterally spaced from each other and geared together to an appropriately modified gear set 80. If the progressive resister is to be shortened to less than an overall height of the rails 4, 6 in which the lifting mechanism 10 is located, multiple progressive resisters 50 could be provided and configured so that progressively greater and greater resistance would be provided through multiple separate progressive resisters 50 having a shorter overall profile.

With particular reference to FIGS. 10 and 11, an alternative embodiment of the lifting mechanism 10 is disclosed, referred to by reference numeral 10′. The lifting mechanism 10′ is similar to the lifting mechanism 10 of the preferred embodiment (FIGS. 4 and 5) except where specifically described herein. In this embodiment of FIGS. 10 and 11, a pair of auxiliary springs 90 are provided adjacent the progressive resister 50, and the combination of spools 30 and springs 40 of the preferred embodiment are placed further outboard away from the progressive resister 50.

Each auxiliary spring 90 includes a housing 92 generally similar to the cavity 42 for the springs 40 of the preferred embodiment. Each auxiliary spring 90 includes an outer end 94 spaced from an inner end 95 which can coact with posts 32′ including slits 33′ coupled to auxiliary spring gears 98. The housings 92 generally define deep cavities 96 in which the auxiliary springs 90 are located.

In this embodiment the auxiliary springs 90 have generally twice the height of the springs 40 of the preferred embodiment. Hence, significantly greater biasing forces can be provided when the auxiliary springs 90 are added to the lifting mechanism 10′. Auxiliary spring bearings 99 allow the auxiliary spring gears 98 to float slightly above the floor of the housing 12 to allow the auxiliary spring gears 98 to freely rotate. The spool gears 82 rotate in a similar direction to that of the preferred embodiment. however, the auxiliary gears 98 rotate in an opposite direction (along arrows I and J of FIG. 10), so that the resistance gear 84 rotates the same direction as the spool gears 82 (along arrow F of FIG. 10).

The auxiliary springs 90 provide significantly greater force tending to cause the spools 30 to collect the cords 80 thereon. Such an arrangement is desirable in situations such as where the window covering 2 is formed of an exceptionally heavy window covering material so that additional lifting force and cord collection force is required to balance the weight of the window covering 2. Similarly, if a heavy bottom rail 6 is provided, or if the entire window covering assembly is configured for use in an exceptionally tall window W (FIG. 1), such auxiliary springs 90 may be necessary or desirable to allow the lifting mechanism 10 to properly balance the window covering assembly.

With particular reference to FIG. 2, another alternative embodiment for the window covering assembly 102 is described. In this embodiment a top rail lifting mechanism 100 is provided. The top rail lifting mechanism 100 is located within the top rail 4 rather than in the bottom rail 6. A top rail cord tension sensor 110 is depicted in FIG. 2. The top rail cord tensor sensor 110 is similar to the cord tension sensor 110 of the preferred embodiment except that it redirects the cord 8 from extending in a horizontal direction within the top rail 4 to extending vertically downward to the bottom rail 6.

Placing the lifting mechanism 100 within the top rail 4 allows the bottom rail 6 to have a smaller configuration. Preferably, when the bottom rail 6 has a lower profile, the bottom rail 6 is provided with sufficient weight so that gravity forces tending to pull the cords 8 out of the cord collector are sufficient to overcome the biasing forces, such as those provided by the springs 40, to keep the lifting mechanism 10 in appropriate equilibrium. In addition to adding weights to the bottom rail 6, or as an alternative thereto, the springs 40 or other biasers can be provided with a lighter force. Additionally, resistance added to the system through the tensioners 110 (FIGS. 3-5) and through the progressive resister 50 would typically need to be appropriately modified to assure proper function of the lifting mechanism 110 located within the top rail 4.

With particular reference to FIG. 1, the use and operation of the lifting mechanism 10 for the window covering assembly 2 of this invention is described. Initially, presume that the bottom rail 6 of the window covering assembly 2 is in an intermediate position as shown in solid lines in FIG. 1. If the user desires to lower the bottom rail 6 so that a greater portion of the window W is covered by the window covering assembly 2, the user grasps the bottom rail 6 and applies a downward force (along arrow A) on the bottom rail 6.

Before applying this downward force, the bottom rail 6 is in equilibrium. Particularly, the lifting mechanism 10 has a portion of the cord 8 wound upon the spools 30. The springs 40 are applying a force on the spools 30 tending to gather additional cord 8 onto the spools 30. A weight of the bottom rail 6 is acting through the pulleys 22 at the cord redirector 20, tending to cause the bottom rail 6 to move downward and causing the cords 8 to be played off of the spools 30.

These gravitational forces and spring 40 or other biasing forces are in equilibrium so that the spools 30 are at rest and the bottom rail 6 is at rest. Additionally, the progressive resister 50 as well as the tensioner 24 are adding additional resistance to cord 8 movement in either direction and spool 30 rotation in either direction to assist in maintaining equilibrium and stationary positioning of the spool 30.

When the user applies a downward force upon the bottom rail 6, this equilibrium is disturbed. Specifically, now both the gravitational forces acting downward on the bottom rail 6 and the forces applied by the user work together to overcome the biasing forces acting upon the spools 30 through the springs 40 and to overcome resistance forces applied by the tensioner 24 and the progressive resister 50. The bottom rail 60 moves down and cord 8 is played off of each of the spools 30.

As the bottom rail 6 moves downward (along arrow A of FIG. 1) the user then releases the bottom rail 6 when the bottom rail 6 is at a position where desired. When the user releases the bottom rail 6, only the gravitational weight forces acting on the bottom rail 6 remain to counteract the spring forces 40 acting upon the spools 30.

So that a new equilibrium condition can be achieved by the lifting mechanism 10, the progressive resister 50 is provided which is progressive in nature. Particularly, with the bottom rail 6 in a lower position, and with more of the cord 8 played off of the spool 30, the springs 40 are applying a greater biasing force upon the spools 30. Also, to some extent a weight of the window covering 2 is partly suspended from the top rail 4 directly, rather than suspended through the bottom rail 6 and the cords 8.

Without the progressive resister 50, the bottom rail 6 would tend to bounce upward and not remain in a fully closed position covering the window W. However, with the progressive resistance 50 provided by the progressive resister 50, the progressive resister 50 is applying a progressively greater amount of resistance to spool 30 rotation as the cord 8 is played off of the spools 30. This resistance applied by the progressive resister 50 is thus sufficient to counteract the biasing forces applied by the springs 40 or other biasers upon the spools 30. Equilibrium is thus maintained when the bottom rail 6 is at the lower position.

When the user wishes to raise the bottom rail 6 (along arrow B of FIG. 1), the user grasps the bottom rail 6 and lifts upward on the bottom rail 6. The user is now applying forces which counter gravity forces acting on the system and working with the forces applied by the springs 40 upon the spools 30. These forces together are sufficient to overcome the forces remaining, including gravity forces acting upon the bottom rail 6 and the resistance forces applied by the progressive resister 50. Hence, as the user lifts the bottom rail 6, the cord 8 is gathered upon the spools 30. When the user releases the bottom rail 6, at any position, after movement upward (along arrow B of FIG. 1), the bottom rail 6 will again be in equilibrium and remain stationary.

While a user's hand is typically considered to be the control force which causes adjustment of the bottom rail 6 of the window covering assembly, other control forces could cause adjustment of the position of the bottom rail 6. For instance, an automatic window covering assembly could be provided where the bottom rail 6 would be raised or lowered by moving along a track, or by the action of separate cords coupled to a control mechanism such as a servo motor and a separate spool to position the bottom rail 6 where desired, such as through use of a remote control assembly. In such a configuration, the lifting mechanism 10 would sufficiently balance the window covering assembly so that a control mechanism could most easily manipulate the position of the bottom rail 6.

The progressive resister preferably provides progressively greater resistance along an entire range of motion of the cords 8 onto the spools 30 and off of the spools 30. The resistance force provided by the progressive resister 50 is preferably generally a linear function of the amount of cord upon the spool 30 and a generally linear function of the position of bottom rail 6 between the top rail 4 and a lowermost position spaced from the top rail 4. As an alternative, the progressive resister 50 could be configured so that it applies no resistance except when needed. For instance, the progressive resister 50 could be configured so that it provides no resistance until the bottom rail 6 is at a middle position, and then provides progressively greater resistance only for a lower half of bottom rail 6 travel. Similarly, the progressive resister 50 could provide progressively greater resistance in a non-linear fashion, such as proportional to a square of the amount of cord upon the spools 30 or other cord collectors. Some other function than a linear function could similarly be provided, with the goal being to allow the bottom rail 6 to remain in equilibrium and stationary at all positions for the bottom rail 6, between a lowermost position most distant from the top rail 4 and an uppermost position closest to the top rail 4. If a window covering 2 having a non-uniform weight distribution is provided, the progressive resister 50 can be appropriately configured to provide resistance when desired to maintain smooth operation of the lifting mechanism 10 for all different positions for the bottom rail 6.

The progressive resister 50 provides a degree of resistance to rotation of the spool 30 which is similar in both directions for the spool 30. Hence, whether the spool 30 is to rotate to gather additional cord 8 thereon or is to rotate to play additional cord 8 off of the spool 30, a similar amount of resistance is provided. The amount of resistance is correlated with the amount of cord 8 which is on the spool 30, which itself correlates with the position of the bottom rail 6 relative to the top rail 4. The progressive resister 50 thus provides resistance in a similar amount in both a lifting direction (along arrow B of FIG. 1) and in a lowering direction (along arrow A of FIG. 1).

With further reference to FIG. 6, details of an alternative spool 230, providing an alternative to the spool 130 and spring 40 combination (FIGS. 3-5) are described. The alternative spool 230 preferably includes a central post 232 about which the alternative spool 230 can rotate. A slit 234 is formed in this post 232 which can receive one end of internal spool spring 240 thereon, to bias the alternative spool 230 towards collecting the cord 8 onto the alternative spool 230. Spool gear 235 is mounted on the alternative spool 230 which can cooperate with the progressive resister 50 or other spools 30 or springs 40 (FIGS. 3-5 and 7-11).

The internal spool spring 240 resides within a cavity 242 inboard of the alternative spool 230. Thus, the alternative spool 230 can have a greater height within a bottom rail 6 (or top rail 4) of fixed height. With such a taller alternative spool 230, a greater number of grooves in the grooved surface 237 can be provided, and a greater number of turns of the cord 8 can be provided before additional turns of the cord 8 need to stack upon previous turns of the cord 8. In typical window coverings, with this arrangement, the cord 8 need not stack upon previous turns of cord more than once or twice, such that a highly consistent amount of cord 8 is used up for repositioning of the window covering 2. Such consistent performance helps to keep the window covering 2 balanced with the bottom rail 6 parallel with the top rail 4 in window coverings 2 which have a pair of cords 8 therein.

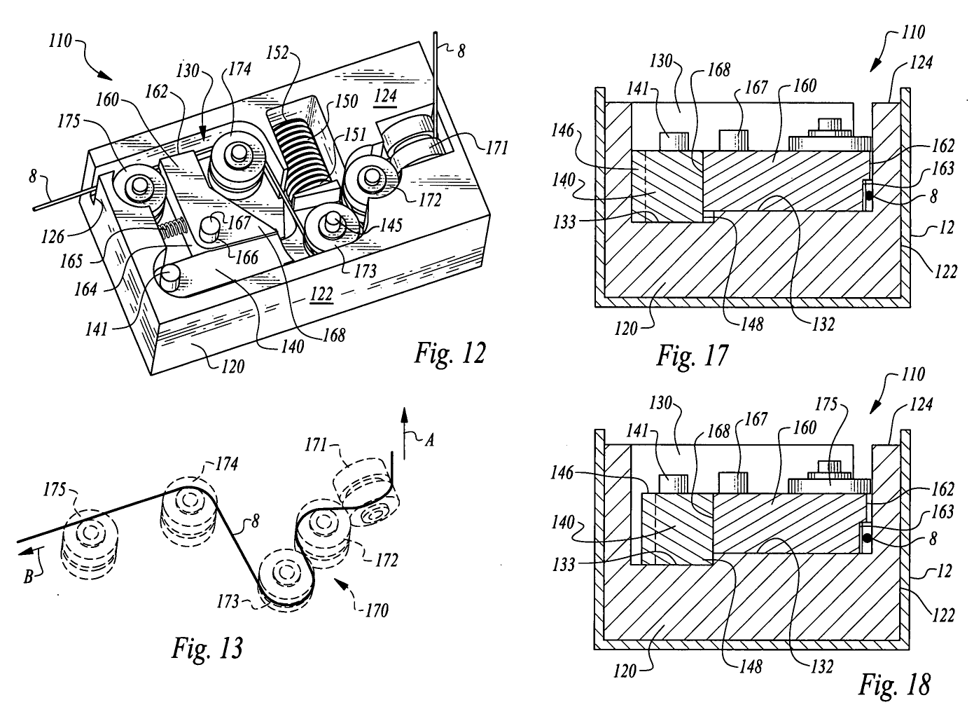

With particular reference to FIGS. 12-19, details of the cord tension sensor 110 are described, according to this preferred embodiment. The cord tension sensor 110 generally acts (when in the bottom rail 6) to redirect the cord 8 from extending vertically within the window covering material to extending horizontally within the bottom rail 6 (or top rail 4). The cord tension sensor 110 also senses tension within the cord 8 and adjusts a friction force applied to the cord 8, both keep the cord tension sufficiently high to avoid slack formation in the cord 8, and also keeping cord friction at a level which reliably cooperates with the lifting mechanism 10, so that the cord 8 can be collected by the lifting mechanism 10 when appropriate, such as when the bottom rail 6 is being lifted. The cord tension sensor 110 is preferably supplied, one for each cord 8, as a compact unit built into the bottom rail 6, but spaced laterally from the housing 12 of the bottom rail 6. If the tension sensor 110 is located in the top rail 4, the sensor 110 can maintain its same configuration or can have various portions thereof rearranged to be a mirror image of that depicted in FIGS. 12-19.

In essence, the tension sensor 110 of this preferred embodiment includes a base 120 in which various other portions of the tension sensor 110 are housed. A cavity 130 is formed extending down into the base 120. This cavity 130 includes contours to receive various different guide rollers 170 (FIG. 13) for routing of the cord 8 through the tension sensor 110. A lever 140 is pivotably supported within the cavity 130 of the base 120. A compression spring 150 is located adjacent a free end 143 of the lever 140 opposite a pivot end 142 of the lever 140. The cord 8 is routed over a roller 173 that moves with the free end 143 of the lever 140, opposite the pivot end 142 of the lever 140, along with compression of the compression spring 150. In this way, the compression spring 150 acts as a tensioner for the cord 8, and also moves when tension increases. The compression spring 150 and lever 140 thus act as a sensor of tension within the cord 8.

A pawl 160 is pivotably mounted within the cavity 130 of the base 120. The pawl 160 has an engagement surface 162 which can move into and out of contact with the cord 8 relative to a reference surface formed by a portion of a side wall 136 of the cavity 130. The pawl 160 is biased toward a position engaging the cord 8 somewhat. When high tension is sensed by the compression spring 150 and lever 140, the lever 140 pivots along with compression of the compression spring 150 sufficiently that the lever 140 abuts the pawl 160 and moves the engagement surface 162 of the pawl 160 into a position off of the cord 8 (FIG. 15). Guide rollers 170 (FIG. 13) are collectively located within the cavity 130 of the base 120 and route the cord 8 precisely where desired through the tension sensor 110. A bobbining roller 180 is preferably supplied between the tension sensor 110 and the lifting mechanism 10, including the cord collector, such as the spools 30 (FIGS. 4 and 5), to help keep the cord 8 routed where desired between the spool 30 and the tension sensor 110.

More specifically, and with particular reference to FIGS. 12 and 17-19, specific details of the base 120 are described, according to this preferred embodiment for the tension sensor 110. The base 120 is preferably a solid rigid unitary mass of material, such as an easily machinable or injection moldable long chain hydrocarbon plastic material. Alternatively, the base 120 could be formed out of aluminum or other metals. The base 120 is generally orthorhombic with parallel opposite side ends, parallel front and rear sides, and a top surface 124 opposite and parallel with a bottom surface. The side walls 122 are perpendicular to the top surface 124. A slit 126 is formed in one of the end outside walls 122 to allow the cord 8 to pass into the tension sensor 110. The cord 8 also accesses the cord sensor 110 through the top surface 124.

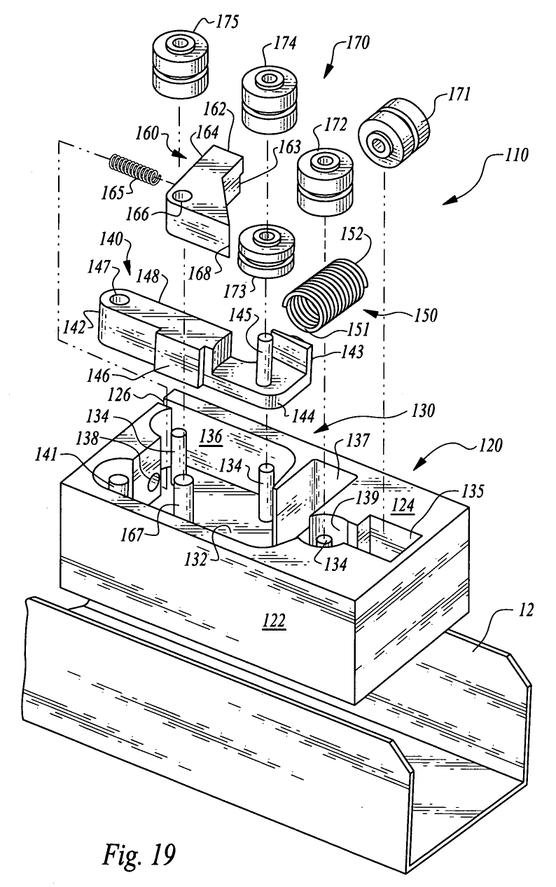

With continuing reference to FIGS. 12 and 17-19, details of the cavity 130 are described according to this preferred embodiment for the tension sensor 110. The cavity 130 is a recess formed down into the top surface 124 of the base 120. The cavity 130 includes a floor 132 which is preferably generally parallel with the top surface 124 of the base 120, but recessed from the top surface 124 by a height of side walls 136 of the cavity 130. Roller pins 134 extend vertically up from the floor 132. These roller pins 134 support various ones of the guide rollers 170 (FIGS. 13 and 19) in the cavity 130, so that the guide rollers 170 can rotate freely. Also, a pawl pin 167 and a lever pin 141 extend vertically up from the floor 132 to rotatably support the lever 140 and the pawl 160 relative to the base 120. A portion of the side walls 136 of the cavity 130 define the reference surface against which the cord 8 is pushed to provide a portion of the variable friction force acting on the cord 8, through movement of the pawl 160 according to this invention.

One of the side walls 136 includes a spring hole 138 therein which extends horizontally perpendicular to a surface of the side wall 136. This spring hole 138 is located to receive one end of a spring 165 which biases the pawl 160 to rotate in a clockwise direction about the pawl pin 167. The pawl 160 is thus biased toward maximum friction engagement, by the engagement surface 162 of the pawl 160, against the cord 8 and toward the reference surface provided by the side wall 136 of the cavity 130.

The cavity 130 also includes a trough 133 (FIGS. 17 and 18) which defines a slightly lower portion of the floor 132 in which the lever 140 resides. The trough 133 is sufficiently wide so that the lever 140 can rotate somewhat, about the lever pin 141, partially within the trough 133. Transition between the trough 133 and other portions of the floor 132 define a stop which keeps the lever 140 from pivoting further than desired in a counter-clockwise direction, responsive to compression of the spring 150 corresponding with high tension sensed in the cord 8.

The cavity 130 also includes an entry alcove 135 in which a first roller 171 can be received in a unique orientation 90° away from the orientation of the other guide rollers 170. A circular chamber 139 is provided adjacent the entry alcove 135 which receives a second roller 172 therein, for further handling of the cord 8. A middle alcove 137 is located adjacent the circular chamber 139 and is generally elongate in form and supports the compression spring 150 therein, as well as roller 173.

Remaining portions of the cavity 130 generally support the pawl 160 and remaining rollers 174, 175 for routing of the cord 8 therethrough and between the engagement surface 162 of the pawl 160 and the reference surface formed by a portion of the side wall 136 of the cavity 130.

With particular reference to FIGS. 12 and 14-19, details of the lever 140 are provided according to a preferred form of the tension sensor 110 of this invention. The lever 140 is a rigid structure pivotably attached to the base 120 at a pivot end 142. A free end 143 of the lever 140 is opposite the pivot end 142 and abuts the compression spring 150. When the compression spring 150 is compressed by enhanced cord tension, the lever 140 pivots in a counter-clockwise direction about the lever pin 141. The lever 140 thus acts (along with the spring 150) as a form of tension sensing element within the tension sensor 110. Other forms of cord 8 tension sensing devices could alternatively be utilized, such as strain gauges.

The lever 140 converts this sensed tension into an activating force acting on the pawl 160 to deactivate the pawl and reduce variable friction forces applied by the pawl 160 on the cord 8. Activation of a pawl 160 by the lever 140 only occurs when high tension is sensed by compression of the compression spring 150 and pivoting of the lever 140. Thus, the lever 140 acts as a primary portion of a variable friction force control system that regulates cord 8 friction response to cord 8 tension.

The lever 140 preferably includes a bend 144 between the pivot end 142 and the free end 143 that is substantially 90°. At this bend 144 a pin 145 extends parallel with the lever pin 141. This pin 145 supports the guide roller 173 thereon. Through this roller 173 the cord 8 is engaged by the tension sensor in the form of the lever 140 and spring 150.

A side of the lever 140 opposite the compression spring 150 preferably includes a bumper 146 thereon. This bumper 146 is adapted to abut portions of the side walls 136 of the cavity 130 adjacent the lever 140, to keep the lever 140 from rotating too far in a clockwise direction and keeping the guide roller 173 mounted on the pin 145 from impacting this side wall 136, so that the guide roller 173 can maintain free rolling operation. As an alternative, this roller 173 can be allowed to drag on the side wall 136 at least a small amount should an increase in cord mount friction be desirable. The pivot end 142 of the lever 140 preferably includes a pin hole 147 which mounts upon the lever pin 141 to allow for rotation of the lever 140 relative to the base 120. An inside surface 148 of the lever 140 is provided opposite the bumper 146. This inside surface 148 selectively abuts a portion of the pawl 160 and causes the pawl 160 to rotate in a counter-clockwise direction when the lever 140 rotates in a counter-clockwise direction, due to compression of the compression spring 150 corresponding with increased tension in the cord 8.

With particular reference to FIGS. 12, 14-16 and 19, details of the compression spring 150 are described, according to this preferred embodiment of the tension sensor 110. The compression spring 150 is preferably a standard helical compression spring with a central axis extending parallel with the top surface 124 of the base 120 and with this central axis generally aligned with a plane in which the cord 8 passes through the tension sensor 110 (FIGS. 12 and 13).

The compression spring 150 includes a first end 151 which abuts against the free end 143 of the lever 140. A second end 152 opposite the first end 151 abuts a portion of the side wall 136 of the cavity 130. The central axis of the compression spring 150 is generally aligned with the pin 145 on the lever 140 and extends perpendicular to a direction of cord 8 motion past the central axis of the compression spring 150. As the cord 8 passes over the guide roller 173 mounted on the pin 145 of the lever 140, if the cord 8 tension is elevated above a preselected amount, the compression spring 150 will be compressed somewhat, causing the lever 140 to rotate in a clockwise direction (arrow N of FIG. 15) and shortening a length of the cord 8 path through the cord tension sensor 110 somewhat. Simultaneously, the lever 140 abuts the pawl 160 causing the pawl 160 to rotate in a counter-clockwise direction (arrow M of FIG. 15) and freeing the cord 8 of substantially any friction between the engagement surface 162 of the pawl 160 and the reference surface in the cavity 130 of the base 120. Thus, when such enhanced cord 8 tension is sensed, low friction is applied to the cord 8.

With particular reference to FIGS. 12 and 14-19, particular details of the pawl 160 are described, according to this preferred embodiment of the cord tension sensor 110 of this invention. The pawl 160 is a substantially rigid mass pivotably mounted relative to the base 120. The pawl 160 can pivot about the pawl pin 167 and move the engagement surface 162 toward and away from a reference surface formed by a portion of the side walls 136 of the cavity 130 of the base 120.

The pawl 160 includes a notch 163 in the engagement surface 162 in at least some embodiments which tends to keep the cord 8 aligned near a middle of the engagement surface 162. This notch 163 can be open on a lower portion thereof (as particularly shown in FIGS. 17 and 18) to facilitate loading of the pawl 160 into the cavity 130, or can be more in the form of a groove, preferably slightly wider than a diameter of the cord so that upper and lower sides of the notch would not drag on the cord 8, but would only keep the cord 8 aligned and centered against the engagement surface 162 of the pawl 160. Most preferably, for simplicity no notch 163 is provided at all.

Portions of the engagement surface 162 above the notch 163 can abut the side wall 136 of the cavity 130, such as when the cord 8 is locked (FIG. 16) by full rotation of the pawl 160 (arrow Q of FIG. 16), by action of the bias spring 165. In this way, the engagement surface 162 can be configured so that friction forces on the cord 8 are limited to a maximum amount when the engagement surface 162 comes into contact with the side wall 136 of the cavity 130.

The pawl 160 includes a pivot hole 166 which rides on the pawl pin 167. A bias spring 165 is oriented with a central axis thereof aligned with the top surface 124 of the base 120 and the floor 132 of the cavity 130. This bias spring 165 biases the pawl 160 toward rotation in a clockwise direction (arrow Q of FIG. 16), unless sufficient forces are applied on the pawl 160 to overcome forces applied by this bias spring 165 (such as by action of the lever 140 upon the pawl 160 depicted by arrow M of FIG. 15 or by action of the cord 8 upon the pawl 160 depicted by arrow L of FIG. 14).

The pawl 160 includes an abutment tip 168 on a portion thereof adjacent the lever 160. This abutment tip 168 comes into contact with the lever 140 when the lever 140 rotates counter-clockwise (arrow N of FIG. 15), such as when elevated cord 8 tension is sensed by compression of the compression spring 150. This abutment tip 168 of the pawl 160 is impacted by the lever 140. The pawl 160 is then caused to rotate in a counter-clockwise direction (arrow M of FIG. 15) about the pawl pin 167 to cause the engagement surface 162 to move away from the reference surface formed by a portion of the side walls 136 of the cavity 130, so that the cord 8 can pass freely through the cord tension sensor 110.

With particular reference to FIGS. 12 and 13, as well as FIGS. 14-19, details of the guide rollers 170 are provided, according to this preferred embodiment of the tension sensor 110 of this invention. The guide rollers 170 are preferably provided to minimize friction on the cord 8 merely due to contact resistance. Through use of the rollers 170, friction on the cord 8 can most fully be controlled and varied. As an alternative, low friction posts could be provided in a stationary manner about which the cord 8 could be routed.

In a preferred embodiment, the guide rollers 170 are each generally include a central hole which acts as a bearing which rides upon a cylindrical pin such as the roller pins 134, or the pin 145 on the lever 140. One exception is the first guide roller 171 which is oriented with a central axis perpendicular to central axes of the other guide rollers 170. Preferably, the entry alcove 135 and the cavity 130 includes additional slots which allow portions of the roller 171 to act as a form of axle to keep the first roller 171 aligned therein. Some form of cap (not shown) or a portion of the top of the bottom rail 6 (or top rail 4) can be provided to keep the first roller 171 down within the entry alcove 135. The second guide roller 172 resides within the circular chamber 139. The third guide roller 173 is mounted on the pin 145 on the lever 140 and adjacent the middle alcove 137 of the cavity 130. The fourth guide roller 174 and fifth guide roller 175 are located on opposite sides of the pawl 160 and route the cord 8 between the engagement surface 162 of the pawl 160 and the reference surface provided by a portion of the side walls 136 of the cavity 130. Each of the guide rollers 170 preferably includes a notch centrally thereon to keep the cord 8 generally in a plane parallel with the top surface 124 of the base 120 and at a midpoint between the top surface 124 and a bottom surface opposite the top surface 124.

With particular reference to FIGS. 1-5 and 10, details of the bobbining roller 180 are described, according to this preferred embodiment. The bobbining roller 180 is preferably provided between the lifting mechanism 10 and the cord tension sensor 110. This bobbining roller 180 includes a sliding post 182 which is fixed in position but which allows the bobbining roller 180 to slide up and down thereon. A bearing 184 in the bobbining roller 180 acts as a journal bearing which receives the sliding post 182 passing therethrough.

The bobbining roller 180 is free to travel up and down on the sliding post 182. As cord 8 is stacked on the spool 30 (preferably including grooves thereon as shown in FIG. 6) it is desirable to keep the cord 8 from stacking upon previous turns of cord 8 on the spool, such as the alternative spool 230 (FIG. 6). To avoid such stacking, the bobbining roller 180 allows cord 8 to move up and down freely so that natural forces applied by the circular cross-section of the cord 8 tend to avoid such stacking upon the spool such as the alternative spool 230.

Furthermore, such stacking is further inhibited by the contact roller 250, shown in detail in FIGS. 3-5 and 10. This contact roller 250 includes an axle 252 coupled to the housing 12 and rotatably supporting the contact roller 250 thereon. A hub 256 is rotatably supported upon the axle 252. A spring 254 biases the contact roller 250 against the cord 8 stacked against the spool, such as the alternative spool 230. Such contact is perhaps best shown in FIG. 5 contacting the spool 30. Arms 257 extend from the hub 256 and rotatably support a wheel 258 thereon. This wheel 258 presses against the cord 8 and resists any tendency of the cord 8 to stack upon previous turns of the cord 8, but rather to spread out against the grooved surface 37 of the spool, such as the alternative spool 230, in a reliable fashion.

With particular reference to FIGS. 20-22, details of an alternative window covering 102 are provided which features a unique structure and size adjustability embodiment for window coverings such as those described in detail above. With this alternative window covering assembly 102 (FIG. 20) a top rail 204 is provided opposite a bottom rail 206. In this embodiment the top rail 204 is shown thin with equipment such as the lifting mechanism 10 and tension sensor 110 (FIG. 1) included in the bottom rail 206. Alternatively, the top rail 204 could be thicker and alternatively be lifting mechanism 10 and tension sensor 110 could be located in the top rail 204 (with the bottom rail 206 thin or thick).

In this embodiment, the top rail 204 includes a measuring guide 205 adjacent each end of the top rail 204. These measuring guides 205 are preferably mirror images of each other, such as with similar graduation lines thereon and indicia adjacent at least some of the lines indicative of width for the window covering 102. Ends of the measurement guide 205 are preferably adjacent ends of the top rail 204.

Indicia adjacent graduation lines at these ends of the measurement guides 205 preferably identify a length similar to that of the top rail 204. Most preferably, such end indicia represent a width of the top rail 204 plus a clearance amount, such as one-quarter inch. In this way, when a user measures a width of a window (e.g. a measurement of thirty-six inches) and when the window covering is cut at a graduation line adjacent the corresponding indicia (the one that identifies “thirty-six inches”) at each end of the window covering 102, the window covering ends up with a width of thirty-five and three-quarters inches. Thus, a one-eighth inch clearance amount is provided at either side of the window covering (when it is mounted within a thirty-six inch wide window). Such a clearance amount is also useful in that many window spaces are not perfectly uniform in width. In this way, a user need merely measure the window and then cut the window covering at each end at graduation lines of the measurement guide 205 which have indicia adjacent thereto which match the width of the window.

Cutting typically occurs with a cutting tool, such as the cutting tool 210 which preferably has a fine serrated edge for cutting of various different fabrics or other materials which form the window covering material between the top rail 204 and bottom rail 206, without snagging or other cutting defects. After such cutting, the window covering 102′ has taken on a shorter length including two excess ends 104 which can then be discarded. End caps 202 are provided on ends of the window covering 102. These end caps 202 can be removed and preferably have just a friction fit over ends of the bottom rail 206. These end caps 202 can be replaced upon remaining portions of the window covering 102′ (FIG. 22). Remaining portions of the measurement guide 205′ would also typically remain on the window covering 102′, since they are out of view once the window covering 102 has been installed.

The bottom rail 206 in this embodiment includes the lifting mechanism 10 and tension sensor 110 (FIG. 1) within the bottom rail 206. Preferably, at extreme ends of the bottom rail 206, just past the tension sensors 110 (FIG. 1) the bottom rail 206 goes from being hollow and containing the lifting mechanism 10 and tension sensor 110, to being filled with an expanded foam 190. This expanded foam 190 is preferably a high density expanded foam which exhibits substantial rigidity and yet can be easily cut.

Shrink tubing 200 is preferably provided outboard of the foam 190. This shrink tubing 200 is formed of a material which shrinks when heat is applied. Thus, the tubing goes from being somewhat loose outboard of the foam 192, to tightly bonding to or pressing against an exterior of the foam 190. The shrink tubing 200 thus acts as a “skin” on the foam 190 and resists cracking or bending failure of the foam 190 and generally adds additional strength to the foam 190, so that the bottom rail 206 has sufficient strength and yet still exhibits lightweight characteristics. This strength can be further enhanced by interposing an adhesive between the foam 190 and the shrink tubing 200. While portions of the foam 190 are exposed by the cutting procedure, the end cap 202 conceal portions of the foam 190 exposed by the cutting procedure.

Typically, the shrink tubing 200 would entirely surround the foam 190 and also surround central portions of the bottom rail 206 containing the lifting mechanism 10 and tension sensor 110. A hole would then be formed in the shrink tubing 200 for passage of the cord 8, and a lowermost portion of the window covering material would be bonded to the shrink tubing 200 on an upper side of the bottom rail 206. Thus, even though the bottom rail 206 has some portions which include mechanisms therein and other portions which are merely filled with foam 190, the entire bottom rail 206 has a consistent appearance between the ends.

While the shrink tubing 200 is shown as one form of outer skin on a foam 190 core forming the bottom rail 206 or other portion of the window covering, other forms of skins could also be provided on such a cuttable foam material for one of the rails (or all of the rails) of a window covering. For instance, adhesive tape could be applied to the foam, spray-on material such as a paint or other material could be applied that then hardens into a skin similar to the shrink tubing 200.

Furthermore, while the foam 190 and shrink tubing 200 is disclosed with regard to the particular type of window covering assembly 2, 102 disclosed in this invention, such a foam core with outer skin type rail could be provided for other forms of window coverings known in the prior art, including blinds and various different forms of pleated shades.

In addition to variations in the number of cords 8 contained within the window covering assembly 2, 102, it is also conceivable that more than two rails could be provided with the window covering. For instance, it is conceivable that a window covering could be provided with a top rail, a bottom rail and at least one intermediate rail. The window covering material would typically extend between the bottom rail and the intermediate rail. Two separate lifting mechanisms could be provided acting on different cords, for instance with one in the bottom rail and one in the intermediate rail (or one in the top rail and one in one of the other rails). The bottom rail would utilize one lifting mechanism either in the bottom rail or in the top rail, with a function as described elsewhere herein.

An intermediate rail is secured to upper portions of the window covering material through the lifting mechanism either within the intermediate rail or within the top rail. The intermediate rail could be moved up or down independently of the bottom rail and on separate cords. Thus, a gap could be provided between the top rail and the intermediate rail to allow light to pass through an upper portion of the window while a lower portion of the window is occluded at least partially by the window covering material suspended between the intermediate rail and the bottom rail. In any such three (or more) rail configuration, a lifting mechanism would be provided for each cord where the cord extends from a fixed end to a lifting mechanism. In such a multiple rail shade, portions of the window covering might include multiple cords adjacent thereto and the intermediate rail might include holes passing therethrough to allow cords associated with the bottom rail to pass through the intermediate rail on its way up to the top rail. As an alternative, the cords suspending the bottom rail might only be between the bottom rail and the intermediate rail.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1: A window covering with reliable automatic cord collection, without requiring pushing of buttons or handling of cords, but rather by merely grasping the bottom rail of the window covering and moving the bottom rail of the window covering to a desired position, the window covering comprising in combination:
an elongate top rail adapted to secure an upper portion of the window covering to a mounting location;
an elongate bottom rail suspended from said top rail with window covering material therebetween;
said bottom rail adapted to move relative to said top rail;
at least one cord extending between said top rail and said bottom rail;
at least one end of said cord adapted to be collected adjacent one of said rails when said bottom rail moves toward said top rail;
a cord collector with at least one of said rails, said cord collector including a cord storage space, said cord collector including a cord collection bias applying a force to pull cord to said cord storage space unless said force is overcome by other forces on said cord; and
a cord tension sensor located along a path of said cord between ends of said cord, said cord tension sensor adapted to apply a variable force on said cord to resist cord motion past said cord tension sensor, said variable force varying depending on tension sensed within said cord.

2: The window covering of claim 1 wherein said cord tension sensor includes an engagement surface that moves relative to a reference surface with said cord passing between said engagement surface and said reference surface, with movement of said engagement surface toward said reference surface increasing force on said cord to resist cord motion past said cord tension sensor, and movement of said engagement surface away from said reference surface decreasing force on said cord to resist cord motion past said cord tension sensor.

3: The window covering of claim 2 wherein said engagement surface pivots relative to said reference surface.

4: The window covering of claim 3 wherein said engagement surface is located on a portion of a pawl, said pawl biased to rotate relative to said reference surface to vary force on said cord to resist cord motion past said reference surface of said cord tension sensor.

5: The window covering of claim 4 wherein said cord tension sensor includes a lever adapted to move to rotate said pawl and decrease the force on said cord to minimize resistance of cord motion past said cord tension sensor when tension on said cord exceeds tension associated with forces applied downward on said bottom rail a selected amount greater than gravity force.

6: The window covering of claim 5 wherein both said pawl and said lever each pivot relative to said reference surface, with said pawl and said lever pivoting about separate pivot points.

7: The window covering of claim 6 wherein said cord tension sensor is located adjacent said bottom rail with said reference surface adapted to move with said bottom rail, said cord tension sensor located adjacent where said cord transitions from horizontal movement within said bottom rail to vertical extension up through said window covering equipment and toward said top rail.

8: The window covering of claim 7 wherein said cord collector includes at least one spool adapted to have cord wrapped thereon, said cord collector including a spring biased to apply said bias force tending to cause cord collection onto said spool.

9: The window covering of claim 8 wherein a bobbining roller is interposed between said cord collector and said cord tension sensor, said bobbining roller adapted to abut said cord and allow said cord to freely roll past said bobbining roller, said bobbining roller adapted to move vertically perpendicular to a direction of cord motion to allow cord collection onto said spool at varying heights, to prevent cord stacking upon said spool.

10: The window covering of claim 9 wherein a contact roller is provided adjacent said spool, said contact roller applying a force on portions of said cord wrapped on said spool tending to press said cord toward said spool and minimize stacking of said cord upon previous turns of said cord upon said spool, said contact roller biased into contact against turns of said cord stacked on said spool.

11: The window covering of claim 2 wherein said cord collector includes at least one spool adapted to have cord wrapped thereon, said cord collector including a spring biased to apply said bias force tending to cause cord collection onto said spool; and
wherein a bobbining roller is interposed between said cord collector and said cord tension sensor, said bobbining roller adapted to abut said cord and allow said cord to freely roll past said bobbining roller, said bobbining roller adapted to move vertically perpendicular to a direction of cord motion to allow cord collection onto said spool at varying heights, to prevent cord stacking upon said spool.

12: The window covering of claim 2 wherein said cord collector includes at least one spool adapted to have cord wrapped thereon, said cord collector including a spring biased to apply said bias force tending to cause cord collection onto said spool; and
wherein a contact roller is provided adjacent said spool, said contact roller applying a force on portions of said cord wrapped on said spool tending to press said cord toward said spool and minimize stacking of said cord upon previous turns of said cord upon said spool, said contact roller biased into contact against turns of said cord stacked on said spool.

13: The window covering of claim 1 wherein said window covering includes at least one rail having a central permanent portion containing said cord collector therein and said cord tension sensor therein, said at least one rail having cuttable portions thereof at each end thereof, such that width of said window covering can be adjusted by variable cutting of said cuttable portions to a desired width; and
said cuttable portions including a relatively high density expanded foam interior surrounded by a heat shrink sleeve heat shrunk onto an exterior surface of said foam.

14: The window covering of claim 13 wherein at least one of said rails of said window covering includes a measuring guide thereon, with said measuring guide located at each of said cuttable portions of said window covering, said measuring guide including graduation lines and indicia adjacent at least some of said graduation lines, said indicia representative of a width of said shade minus a clearance space for said window shade to reside within a window space, after having been cut at each of said ends an equal amount at a graduation line having a similar indicia at each end; and
wherein an end cap is provided removably attachable to said cuttable ends, said end caps adapted to be removed from said cuttable ends after cutting of said cuttable ends and replaced on remaining portions of said cuttable ends still coupled to said central permanent portion after cutting of said cuttable ends.

15: A cord tension sensor for applying a variable force on a cord responsive to tension in the cord, the cord tension sensor comprising in combination:
an engagement surface;
a reference surface;
a cord passing between said engagement surface and said reference surface;
said engagement surface adapted to move relative to said reference surface with movement of said engagement surface toward said reference surface increasing friction force on the cord and movement of the engagement surface away from the reference surface decreasing friction force on the cord;
said engagement surface biased to move to increase friction force on the cord;
a tensioner member located within the cord tension sensor, said tensioner member positioned with the cord routed past said tensioner member and abutting said tensioner member;
said tensioner member adapted to be variably displaced lateral to a direction of cord motion past said tensioner member, depending on tension in the cord, with increased tension in the cord increasing tensioner member displacement;
said tensioner member biased toward a direction tending to move said tensioner member toward said cord; and
said tensioner member adapted to move said engagement surface away from said reference surface when tension on the cord exceeds a preselected tension amount, to reduce friction force on the cord when said preselected tension amount has been exceeded.

16: The cord tension sensor of claim 15 wherein said engagement surface pivots relative to said reference surface.

17: The cord tension sensor of claim 16 wherein a lever is pivotably mounted relative to said reference surface, said lever adapted to pivot with said tensioner member, said engagement surface rotated upon a pawl which pivots relative to said reference surface, said lever adapted to abut said pawl and rotate said pawl to move said engagement surface away from said reference surface when tension in the cord exceeds said preselected tension amount.

18: The cord tension sensor of claim 15 wherein said cord tension sensor is located within a rail of a window covering having an elongate top rail adapted to secure an upper portion of the window covering to a mounting location, an elongate bottom rail suspended from the top rail with window covering material therebetween, said bottom rail adapted to move relative to said top rail, the cord extending between said top rail and said bottom rail, at least one end of the cord adapted to be collected adjacent one of said rails when said bottom rail moves toward said top rail, and a cord collector with at least one of said rails, said cord collector including a cord storage space, said cord collector including a cord collection bias applying a force to pull cords to said cord storage space unless said force is overcome by other forces on the cord.

19: The cord tension sensor of claim 15 wherein a cord collector is provided on one side of said cord tension sensor with the cord extending between said cord collector and said cord tension sensor, said cord collector including a spool, the cord collector including a spring biased to apply a force tending to cause the cord to be collected onto said spool.

20: The cord tension sensor of claim 19 wherein a bobbining roller is interposed between the cord collector and the cord tension sensor, said bobbining roller adapted to abut the cord and allow the cord to freely roll past said bobbining roller, said bobbining roller adapted to move vertically perpendicular to a direction of cord motion to allow cord collection onto said spool at varying heights, to prevent cord stacking upon said spool.

21: The cord tension sensor of claim 19 wherein a contact roller is provided adjacent said spool, said contact roller applying a force on portions of the cord wrapped on said spool tending to press the cord toward said spool and minimize stacking of the cord upon previous turns of the cord upon said spool, said contact roller biased into contact against turns of the cord stacked on said spool.

22: A method for controlling cord motion resistance forces in a window covering to facilitate automatic cord collection in a height adjustable window covering, including the steps of:
providing a window covering having an elongate top rail adapted to secure an upper portion of the window covering to a mounting location; an elongate bottom rail suspended from the top rail with window covering material therebetween; the bottom rail adapted to move relative to the top rail; at least one cord extending between the top rail and the bottom rail; at least one end of the cord adapted to be collected adjacent one of the rails when the bottom rail moves toward the top rail; and a cord collector with at least one of the rails, the cord collector including a cord storage space, the cord collector including a cord collection bias applying a force to pull cord to the cord storage space unless the force is overcome by other forces on the cord; and
applying a variable resistance force on the cord to keep the bottom rail of the window covering static at varying positions relative to the top rail and allow cord collection by the cord collector when the bottom rail is lifted and allow cord release by the cord collector when the bottom rail is lowered.

23: The method of claim 22 including the further step of maximizing the variable resistance force when the bottom rail is static with no forces other than gravity forces acting thereon.

24: The method of claim 22 including the further step of minimizing the variable resistance force when the bottom rail is lowered.

25: The method of claim 22 including the further step of setting the variable resistance force below the cord collection bias force of the cord collector when the bottom rail is raised.

26: The method of claim 25 wherein said setting step includes setting the variable resistance force between a maximum variable resistance force and a minimum variable resistance force with the maximum variable resistance force applied when the bottom rail is static and the minimum variable resistance force applied when the bottom rail is lowered.

27: The method of claim 22 wherein said applying step includes the steps of:
sensing tension in the cord; and
lowering the variable resistance force when the tension sensed by said sensing step is greater than cord tension associated with gravity loads alone.
